(19) United States
(12) Patent Application Publication
(10) Pub. No.: US 2024/0101882 A1
(43) Pub. Date: Mar. 28, 2024

(54) ABRASIVE PARTICLES INCLUDING COATING, ABRASIVE ARTICLE INCLUDING THE ABRASIVE PARTICLES, AND METHOD OF FORMING

(71) Applicants: SAINT-GOBAIN ABRASIVES, INC., Worcester, MA (US); SAINT-GOBAIN ABRASIFS, Conflans-Sainte-Honorine (FR)

(72) Inventors: Zehua SHI, Shanghai (CN); Daming LI, Shanghai (CN); Xiaochao SONG, Shanghai (CN); Jianfeng ZHANG, Shanghai (CN); Haoran NIU, Shanghai (CN); Benjamin LEVEILLE, Thompson, CT (US); Melissa BECKER, Somerville, MA (US); Zhenyu LUO, Shanghai (CN); Aiyun LUO, Shanghai (CN)

(21) Appl. No.: 18/472,972

(22) Filed: Sep. 22, 2023

(30) Foreign Application Priority Data
Sep. 23, 2022 (CN) 202211169190.0
Jun. 21, 2023 (CN) 202310743048.0

(51) Int. Cl. C09K 3/14

(52) U.S. Cl. CPC C09K 3/1409

(57) ABSTRACT

The following is directed to an abrasive particle having a body including a core and a coating overlying at least a portion of the core. The coating can include a content of lithium. In an embodiment, the coating can further include silicon, oxygen, or a combination thereof.

### CROSS-REFERENCE TO RELATED APPLICATION(S)

This application claims priority to Chinese Patent Application No. 202211169190.0, entitled “ABRASIVE PARTICLES INCLUDING COATING, ABRASIVE ARTICLE INCLUDING THE ABRASIVE PARTICLES, AND METHOD OF FORMING,” by Zehua SHI et al., filed Sep. 23, 2022, and Chinese Patent Application No. 202310743048.0, entitled “ABRASIVE PARTICLES INCLUDING COATING, ABRASIVE ARTICLE INCLUDING THE ABRASIVE PARTICLES, AND METHOD OF FORMING,” by Zehua SHI et al., filed Jun. 21, 2023, which are assigned to the current assignee hereof and incorporated herein by reference in their entireties.

### FIELD OF THE DISCLOSURE

The following is directed to abrasive particles including a coating overlying a portion of a core, abrasive articles including the abrasive particles, and methods of forming.

### DESCRIPTION OF THE RELATED ART

Abrasive articles are used in material removal operations, such as cutting, grinding, or shaping various materials. Fixed abrasive articles include abrasive particles held in a bond material. The bond material can include an organic and/or inorganic material. Organic bond abrasive articles often perform poorly under wet grinding conditions. Specifically, in a wet grinding operation. The industry continues to demand improved abrasive articles.

### BRIEF DESCRIPTION OF THE DRAWINGS

The present disclosure may be better understood, and its numerous features and advantages made apparent to those skilled in the art by referencing the accompanying drawings.

FIG. 1 includes a flowchart illustrating a process for forming abrasive particles, wherein each abrasive particle can include a coating overlying a core according to an embodiment.

FIGS. 2A and 2B include illustrations of cross sections of abrasive particles according to embodiments.

FIG. 3 includes an atomic force microscopic image of an abrasive particle.

FIG. 4 includes an illustration of a cross section of a bonded abrasive article according to an embodiment.

FIG. 5 includes an illustration of a process of forming an abrasive article according to an embodiment.

FIG. 6 includes an illustration of a cross section of a coated abrasive article according to an embodiment.

FIG. 7 includes a photograph of Comparative Example 7.

FIGS. 8A and 8B include SEM images of cores of abrasive particles of embodiments herein.

FIG. 9 includes a plot of G-ratios vs. MRR of abrasive wheel samples.

FIGS. 10A to 10H include SEM images of samples of abrasive particles.

FIGS. 11A to 11D include SEM images of additional samples of abrasive particles.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments are directed to abrasive particles, wherein each abrasive particle can include a coating overlying a core. The abrasive particles can include a batch of abrasive particles or otherwise have a suitable sample size that is statically relevant. The abrasive particles can be suitable for forming various abrasive articles including, for example, fixed abrasive articles, such as bonded abrasives, coated abrasives, and superabrasive articles. The abrasive particles can have improved bonding to the bond material contained in an abrasive article and facilitate improved performance of the abrasive article.

Embodiments further relate to process of forming the abrasive particles. The process can include a drying treatment to facilitate formation of a coating that has improved properties. For example, the process can allow formation of abrasive particles having improved average thickness of the coating, improved standard deviation of the coating thickness, and improved morphology of the abrasive particles. In another instance, the coating can facilitate improved moisture resistance of the abrasive particles and formation of an interface that has improved moisture resistance between the abrasive particles and the bond material in an abrasive article.

Further embodiments are directed to abrasive articles including a bond material and the abrasive particles. The abrasive articles can have improved bonding between the bond material and abrasive particles, which in turn can help improve performance and/or properties of abrasive articles. For example, abrasive articles of embodiments herein can have improved grinding performance under wet conditions, improved performance after aging, and extended service life.

The abrasive articles can include a fixed abrasive article including, for example, coated abrasives, such as a belt and a disc, bonded abrasives including organic bond materials and/or inorganic bond materials, and superabrasive tools. Exemplary bonded abrasive articles can include, for instance, grinding wheels, cutoff wheels, ultra-thin wheels, combination wheels, cutting wheels, chop saws, or any combination thereof.

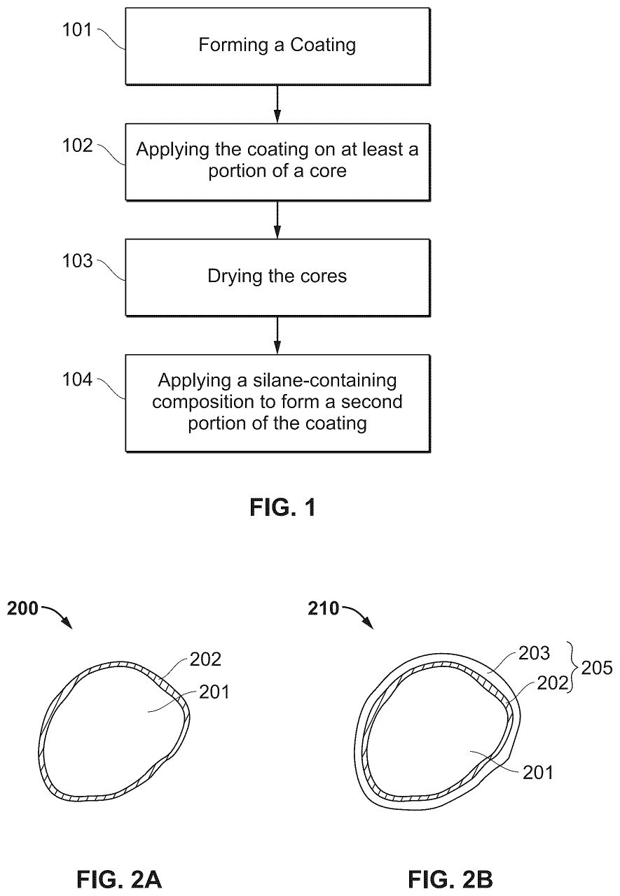

FIG. 1 includes a flowchart illustrating an exemplary process of forming abrasive particles, wherein each abrasive particle can include a coating overlying a core. At block 101, the process can include forming a coating. Forming a coating can include forming a mixture including a first material, a second material, and optionally, a third material. Suitable mixing operations can be utilized to achieve homogenous dispersion of the components within the mixture.

Formation of the coating can include forming a mixture including a first material including silica. For example, the first material can include a dispersion of silica in a solvent. The solvent can be aqueous or an organic solvent. In an aspect, the first material can include silica nanoparticles. In one embodiment, the first material can be silica nanoparticle dispersion in water.

In another aspect, the coating can include a particular content of the first material including silicon (i.e., silica) for a total weight of the mixture or for a total weight of a first portion of a coating (e.g., 202) that can facilitate improved formation and properties of the coating. For example, the mixture and resulting coating can include at least 10 wt % of the first material including silicon for a total weight of the mixture, such as at least 15 wt %, at least 20 wt %, at least 30 wt %, at least 40 wt %, at least 50 wt %, at least 60 wt %, at least 70 wt %, or at least 80 wt % for a total weight of the mixture. In another instance, the mixture may include not greater than 95 wt % of the first material including silicon for a total weight of the mixture, such as not greater than 90 wt %, or not greater than 85 wt %, for a total weight of the mixture. It will be understood that the mixture can include the first material including silicon in a content including any of the minimum and maximum percentages noted herein. Unless specified otherwise, the contents of any species (e.g., silicon, lithium, potassium, sodium, aluminum, etc.) are calculated by ICP analysis as described in the measurement of the abrasive particles of Example 1 (Sample S1) provided herein. As used herein, ICP may be performed using ICP-OES Agilent 5110 or equivalent. Grain samples may be prepared as follows: weighing 0.5000±0.0100 grams of a grain sample and 3.0000±0.0100 g of Lithium Tetraborat and adding into a Pt/Au crucible; adding 200 μl solution of lithium bromide into the crucible and mixing well; melting the mixture at 1300±30° C. and then cooling to form a fused sample; transferring the fused sample into a beaker; adding approximately 125 mL of DI H₂O and 25 mL of HCl into the beaker and heating and then cooling to obtain a solution; and performing the ICP test on the solution.

Formation of the coating can include forming a mixture including a second material including lithium. For example, the second material can include lithium silicate. In a particular embodiment, the coating can include a particular content of the second material including lithium for a total weight of the mixture that can facilitate improved formation and properties of the coating. For example, the mixture can include at least 10 wt % of the second material including lithium for a total weight of the mixture, such as at least 15 wt %, at least 20 wt %, at least 30 wt %, at least 40 wt %, at least 50 wt %, at least 60 wt %, at least 70 wt %, or at least 80 wt % for a total weight of the mixture. In another instance, the mixture may include not greater than 95 wt % of the second material including lithium for a total weight of the mixture, such as not greater than 90 wt %, or not greater than 85 wt %, for a total weight of the mixture. It will be understood that the mixture can include the second material including lithium in a content including any of the minimum and maximum percentages noted herein.

In one non-limiting embodiment, formation of the coating, such as a first portion of the coating can include forming a mixture including an optional third material including potassium. For example, the third material can include potassium silicate. In a particular embodiment, the coating can include a particular content of the third material for a total weight of the mixture that can facilitate improved formation and properties of the coating. For example, the mixture can include at least 0.01 wt % of the third material including potassium for a total weight of the mixture, such as at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, or at least 50 wt % for a total weight of the mixture. In another instance, the mixture may include not greater than 70 wt % of the third material including potassium for a total weight of the mixture, such as not greater than 65 wt %, not greater than 60 wt %, or not greater than 55 wt % for a total weight of the mixture. Moreover, the mixture can include the third material including potassium in a content including any of the minimum and maximum percentages noted herein.

In still other embodiments, formation of the coating can include forming a mixture including an optional fourth material including sodium. For example, the fourth material can include sodium silicate. In a particular embodiment, the coating can include a particular content of the fourth material for a total weight of the mixture that can facilitate improved formation and properties of the coating. For example, the mixture can include at least 0.01 wt % of the fourth material including sodium for a total weight of the mixture, such as at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, or at least 50 wt % for a total weight of the mixture. In another instance, the mixture may include not greater than 70 wt % of the fourth material including sodium for a total weight of the mixture, such as not greater than 65 wt %, not greater than 60 wt %, or not greater than 55 wt % for a total weight of the mixture. Moreover, the mixture can include the fourth material including sodium in a content including any of the minimum and maximum percentages noted herein.

Referring now to block 102 or FIG. 1, the process can further include applying the coating on at least a portion of a core. Applying a coating on at least a portion of the core can include mixing cores with the mixture formed in block 101. Mixing equipment may be used to facilitate formation of uniform mixture of cores and the mixture. Examples of mixing equipment can include Hobart mixers, Hudson mixers, or the like, or another mixing device.

In a next step at block 103 of FIG. 1, the process can further include drying the cores coated with the mixture. Drying can include drying at a temperature sufficient to form the coating overlying at least a portion of the core. Particularly, drying can be conducted at a temperature of at least 15° C. or at least 20° C. or at least 30° C. or at least 40° C. or at least 50° C. such as at least 60° C. or at least 70° C. or at least 80° C. or at least 90° C. or at least 100° C., such as at least 120° C. or at least 150° C. In still another instance, the drying temperature may be not greater than 400° C., such as not greater than 350° C., not greater than 300° C., not greater than 250° C., not greater than 200° C., such as not greater than 190° C., not greater than 180° C., not greater than 170° C., or not greater than 160° C. Moreover, the drying temperature can be in a range including any of the minimum and maximum temperatures noted herein. In a particular instance, the drying temperature can be in a range from 100° C. to 180° C. or in a range from 140° C. to 150° C.

In an aspect, drying can be performed in an oven. In another aspect, drying can be performed for a certain period of time sufficient for forming a dried coating on the cores. For instance, drying can include drying the cores having a coating for at least 2 hours, such as at least 4 hours, at least 6 hours, at least 8 hours, at least 10 hours, at least 12 hours or at least 14 hours. In another instance, drying the cores having a coating may be performed for not greater than 20 hours, such as not greater than 18 hours, or not greater than 16 hours. Moreover, drying can include drying the cores having a coating for a time period in a range including any of the minimum and maximum values noted herein. In a particular example, drying can include drying the cores having a coating from 12 hours to 16 hours.

It is notable the forming process disclosed in embodiments herein can allow improved formation of abrasive particles. For instance, the abrasive particles as dried may include not greater than 30 wt % of agglomerated abrasive particles for a total weight of the dried abrasive particles, such as not greater than 25 wt %, not greater than 20 wt %, not greater than 15%, not greater than 10 wt %, not greater than 5 wt %, not greater than 2 wt %, not greater than 1 wt %, not greater than 0.8 wt %, not greater than 0.5%, not greater than 0.3 wt %, or not greater than 0.1 wt % of agglomerated abrasive particles for a total weight of the dried abrasive particles. In particular instances, the dried abrasive particles can consist essentially of loose abrasive particles.

In an embodiment, a core can include an abrasive material including a crystalline material, such as a polycrystalline material, a monocrystalline material, or a combination thereof, an amorphous material, a ceramic material, a glass-ceramic material, superabrasives, minerals, a carbon-based material, or any combination thereof. In a further aspect, the sintered ceramic material can include oxides, carbides, nitrides, borides, oxycarbides, oxynitrides, silicates, or any combination thereof. For instance, core can include a material selected from the group of silicon dioxide, silicon carbide, alumina, zirconia, flint, garnet, emery, rare earth oxides, rare earth-containing materials, cerium oxide, sol-gel derived particles, gypsum, iron oxide, glass-containing particles, and a combination thereof. In another instance, abrasive particles may also include silicon carbide (e.g., Green 39C and Black 37C), brown fused alumina (57A), seeded gel abrasive, sintered alumina with additives, shaped and sintered aluminum oxide, pink alumina, ruby alumina (e.g., 25A and 86A), electrofused monocrystalline alumina 32A, MA88, alumina zirconia abrasives (e.g., NZ, NV, ZF Brand from Saint-Gobain Corporation), extruded bauxite, sintered bauxite, cubic boron nitride, diamond, aluminum oxy-nitride, sintered alumina (e.g., Treibacher's CCCSK), extruded alumina (e.g., SR1, TG, and TGII available from Saint-Gobain Corporation), or any combination thereof. In another example, core can have a Mohs hardness or at least 7, such as at least 8, or even at least 9.

In another embodiment, the core can include non-agglomerated particle, non-shaped abrasive particles, shaped abrasive particle, or any combination thereof. For example, the core can include shaped abrasive particles as disclosed for example, in US 20150291865, US 20150291866, and US 20150291867. Shaped abrasive particles are formed such that each particle has substantially the same arrangement of surfaces and edges relative to each other for shaped abrasive particles having the same two-dimensional and three-dimensional shapes. As such, shaped abrasive particles can have a high shape fidelity and consistency in the arrangement of the surfaces and edges relative to other shaped abrasive particles of the group having the same two-dimensional and three-dimensional shape. By contrast, non-shaped abrasive particles can be formed through different process and have different shape attributes. For example, non-shaped abrasive particles are typically formed by a comminution process, wherein a mass of material is formed and then crushed and sieved to obtain abrasive particles of a certain size. However, a non-shaped abrasive particle will have a generally random arrangement of the surfaces and edges, and generally will lack any recognizable two-dimensional or three-dimensional shape in the arrangement of the surfaces and edges around the body. Moreover, non-shaped abrasive particles of the same group or batch generally lack a consistent shape with respect to each other, such that the surfaces and edges are randomly arranged when compared to each other. Therefore, non-shaped grains or crushed grains have a significantly lower shape fidelity compared to shaped abrasive particles.

In a particular embodiment, the core can include a sintered ceramic material having a particular average crystallite size. In an aspect, the average crystallite size can be less than 1 micron, such as not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns. In another aspect, the core 201 can include a sintered ceramic material having an average crystallite size of at least 0.01 microns, such as at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, or at least 0.4 microns, or at least 0.5 microns. Moreover, the core can include a sintered ceramic material including an average crystallite size in a range including any of the minimum and maximum values noted herein. For instance, the core can include a sintered ceramic material having an average crystallite size in a range including at least 0.01 microns and less than 1 micron, in a range including at least 0.03 microns and not greater than 0.8 microns, in a range including at least 0.05 microns and not greater than 0.6 microns, in a range including at least 0.08 microns and not greater than 0.4 microns, or in a range including at least 0.1 microns and not greater than 0.2 microns. The average crystallite size can be measured by an uncorrected intercept method by SEM micrographs.

A particular example of sintered ceramic material can include alumina (Al₂O₃), including, for example, microcrystalline alumina (e.g., sol-gel alumina), nanocrystalline alumina, fused alumina, such as brown fused alumina, or a combination thereof. Particularly, alumina (Al₂O₃) can include alpha alumina (α-Al₂O₃).

In a particular aspect, the core can include a polycrystalline alpha alumina (α-Al₂O₃), and more particularly, the polycrystalline alpha alumina (α-Al₂O₃) can include an average crystallite size less than 1 micron, such as the average crystallite size as described with respect to the sintered ceramic material. In an even more particular aspect, the core can consist essentially of polycrystalline alpha alumina (α-Al₂O₃) including an average crystallite size of less than 1 micron.

In an embodiment, the core can include a density of at least 80% of its theoretical density, such as at least 85%, at least 88%, at least 90%, at least 92%, at least 95%, or at least 98% of its theoretical density. In another embodiment, the core may include a porosity not greater than 10 vol % for a total volume of the core, not greater than 9 vol %, not greater than 8 vol %, not greater than 7 vol %, not greater than 6 vol %, not greater than 5 vol %, not greater than 4 vol %, not greater than 3 vol %, not greater than 2 vol %, or not greater than 1 vol % for the total volume of the core. In a particular embodiment, the core can be essentially free of pores. The true density of the core was measured by first measuring the bulk density of the core. The bulk density of core was measured by Pycnometer (Quantachrome Ultrapycnometer 1000) with ultrahigh purity compressed Helium regulated to pressure of 20 psig. The core was then crushed into a powder state and the true density was measured with the same method above with the Pycnometer. The porosity of the core is calculated by the following calculation (porosity=[true density−bulk density]/[true density]).

In a further embodiment, the core can have the density of the sintered ceramic material that forms the core. For example, depending on the sintered ceramic material, the core can include a density of at least 2.10 g/cm³, at least 2.20 g/cm³, 2.30 g/cm³, at least 2.40 g/cm³, at least 2.50 g/cm³, at least 2.60 g/cm³, at least 2.70 g/cm³, 2.80 g/cm³, at least 2.90 g/cm³, at least 3.00 g/cm³, at least 3.10 g/cm³, at least 3.20 g/cm³, at least 3.30 g/cm³, at least 3.40 g/cm³, 3.50 g/cm³, at least 3.55 g/cm³, at least 3.60 g/cm³, at least 3.65 g/cm³, at least 3.70 g/cm³, at least 3.75 g/cm³, at least 3.80 g/cm³, at least 3.85 g/cm³, at least 3.90 g/cm³, or at least 3.95 g/cm³. Additionally or alternatively, the core can include a density of not greater than 5.80 g/cm³, not greater than 5.70 g/cm³, not greater than 5.60 g/cm³, not greater than 5.50 g/cm³, not greater than 5.40 g/cm³, not greater than 5.30 g/cm³, not greater than 5.20 g/cm³, not greater than 5.10 g/cm³, not greater than 5.00 g/cm³, not greater than 4.90 g/cm³, not greater than 4.80 g/cm³, not greater than 4.70 g/cm³, not greater than 4.60 g/cm³, not greater than 4.50 g/cm³, not greater than 4.40 g/cm³, not greater than 4.30 g/cm³, not greater than 4.20 g/cm³, not greater than 4.10 g/cm³, not greater than 4.00 g/cm³, or not greater than 3.97 g/cm³. In a further example, the core can have a density in a range including any of the minimum and maximum values noted herein.

In an embodiment, the core may include alumina and one or more of a rare earth oxide, an alkaline earth oxide, or any combination thereof. In an aspect, the core may include at least 90 wt % of alumina and a total of not greater than 10 wt % of one or more other oxides for a total weight of the core. For example, the core may include at least 93 wt % and not greater than 98 wt % of alumina, a total of at least 1.5 wt % and not greater than 7 wt % of one or more rare earth oxides, and up to 2 wt % of alkaline earth oxides. In another embodiment, the core may include a particular content ratio of rare earth oxides to alkaline earth oxides, C_{RRO}/C_{AEO}, wherein C_{RRO} is the total content of rare earth oxides, and C_{AEO} is the total content of alkaline earth oxides. For example, the ratio, C_{RRO}/C_{AEO}, may be at least 1.1, such as at least 1.5, at least 1.8, at least 2, at least 2.3, at least 2.5, at least 2.8, at least 3, at least 3.2, at least 3.5, at least 3.7, at least 3.9, or at least 4. In another example, the core may a ratio of C_{RRO}/C_{AEO} of not greater than 10, not greater than 9, not greater than 8, not greater than 7, not greater than 6, or not greater than 5. Moreover, the ratio C_{RRO}/C_{AEO} may be in a range including any of the minimum and maximum values noted herein.

In another embodiment, the core may include a particular crystalline structure including a primary crystalline phase including alumina and a secondary magnetoplumbite crystalline phase including aluminate. In a particular embodiment, the core may include a magnetoplumbite crystalline phase including aluminate including one or more of rare earth elements and/or one or more of alkaline earth elements. In a further embodiment, the core may include La₂O₃, Y₂O₃, or a combination thereof. In a particular example, the core may include a higher content of La₂O₃ than Y₂O₃. In another example, the core may include at least 1 wt % of La₂O₃ for a total weight of the core, such as at least 1.5 wt %, at least 2 wt %, at least 2.5 wt %, at least 2.7 wt %, at least 2.8 wt %, at least 3 wt %, at least 3.1 wt %, or at least 3.2 wt % of La₂O₃ for a total weight of the core. Additionally or alternatively, the core may include not greater than 8 wt % of La₂O₃ for a total weight of the core, such as not greater than 7 wt %, not greater than 6 wt %, not greater than 5 wt %, not greater than 4 wt %, or not greater than 3.5% of La₂O₃ for a total weight of the core. Moreover, the core may include a content of La₂O₃ in a range including any of the minimum and maximum percentages noted herein. In another example, the core may include at least 0.3 wt % of Y₂O₃ for a total weight of the core, such as at least 0.4 wt %, at least 0.5 wt %, at least 0.6 wt %, at least 0.7 wt %, at least 0.8 wt %, or at least 0.9 wt % of Y₂O₃ for a total weight of the core. Additionally or alternatively, the core may include not greater than 3 wt % of Y₂O₃ for a total weight of the core, such as not greater than 2.7 wt %, not greater than 2.5 wt %, not greater than 2.3 wt %, not greater than 2 wt %, not greater than 1.7 wt %, not greater than 1.5 wt %, not greater than 1.3 wt %, not greater than 1.1 wt %, or not greater than 1% of Y₂O₃ for a total weight of the core. Moreover, the core may include a content of Y₂O₃ in a range including any of the minimum and maximum percentages noted herein. In a particular embodiment, the core may include a magnetoplumbite crystalline phase including aluminate including La₂O₃ and Y₂O₃.

In certain embodiment, the core may be essentially free of ZrO₂. In at least one other embodiment, the core may include ZrO₂. In another particular embodiment, the core may include a secondary magnetoplumbite crystalline phase including MgO. In a particular example, the core may include a content MgO in a range of at least 0.5 wt % to not greater than 2 wt % for a total weight of the core, such as in a range of at least 0.7 wt % to not greater than 1.6 wt %, or in a range of at least 0.8 wt % to not greater than 1.4 wt % for a total weight of the core.

In another embodiment, the core may include a particular HV hardness. For example, the core may have a HV hardness of at least 1800, at least 1850, at least 1900, at least 1920, at least 1950, at least 1970, at least 2000, at least 2100, or at least 2200. In another example, the core may have a HV hardness of not greater than 2500, such as not greater than 2400, not greater than 2300, not greater than 2200, not greater than 2100, not greater than 2000, not greater than 1990, or not greater than 1980. Moreover, the core may include a HV hardness in a range including any of the minimum and maximum values noted herein. HV hardness may be determined according to ASTM C1327-15 using Vickers Hardness Tester LM100AT. Grain samples may be prepared as follows. Grains may be mounted using resins to obtain a cylinder specimen with a 25 mm diameter. The specimen may be polished to obtain a damage-free surface that may be used for hardness testing.

In one embodiment, the forming process may stop at step 103 with a particle having a structure as generally provided in FIG. 2A including a core 201 and a coating 202, wherein the coating includes an inorganic material.

In an alternative embodiment, the process may continue after step 103 to step 104, which includes the optional process of the application of an organic material. Such a process may be conducted prior to incorporation of the abrasive particles into a fixed abrasive. According to one embodiment, the process at step 104 includes forming a second portion (e.g., 203) of the coating overlying at least some of the first portion (e.g., 202) of the coating. In one instance, the second portion may include an organic-containing material. In one non-limiting embodiment, the organic-containing material may include a material that may facilitate bonding of the abrasive particles to a bond material, such as an organic-containing bond composition (e.g., phenolic resin, epoxy, etc.). In one particular process, the organic-containing material that may be included in the second portion may be a silane-containing material and/or a silanol-containing material. For example, according to the process of FIG. 1, the process at step 104 may include forming a second portion of the coating on the abrasive particles, wherein such particles may have a general structure as provided in the embodiment of FIG. 2B. Reference herein to the content of inorganic material, such as compositions from the first portion 202 of the coating are based on the weight percent of the first portion.

The coating 202 can be in direct contact with the core 201. As illustrated, the coating 202 can be a layer overlying the entire surface of the core 201. In at least one embodiment, the coating 202 may be overlying a majority of the surface of the core 201, and a portion of the core surface may not be covered by the coating 202. In a particular embodiment, the coating can include a dried material. In still another embodiment, the coating can include an unsintered material.

In an embodiment, the coating can have a particular percent ratio of lithium content to a content of silicon that can facilitate improved formation and properties of abrasive particle 200 or 210 as illustrated in FIG. 2A or 2B, respectively. In an embodiment, the lithium may include a lithium-containing compound. In another aspect, the lithium-containing compound may include an oxide. In still another embodiment, the lithium-containing compound may include lithium oxide. In an embodiment, the silicon may include a silicon-containing compound. In another aspect, the silicon-containing compound may include an oxide. In still another embodiment, the silicon-containing compound may include silicon dioxide. In an aspect, the percent ratio of lithium/silicon may be at least 0.02% or at least 0.03% or at least 0.04% or at least 0.05% or at least 0.06% or at least 0.07% or at least 0.08%, at least 0.1% or at least 0.2% or at least 0.3% or at least 0.4% or at least 0.5% or at least 0.6% or at least 0.7% or at least 0.8% or at least 0.9% or at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0%. In still other embodiments, the percent ratio of lithium/silicon may be not greater than 250% or not greater than 220% or not greater than 220% or not greater than 180% or not greater than 150% or not greater than 120% or not greater than 100% or not greater than 90% or not greater than 80% or not greater than 70% or not greater than 60% or not greater than 50% or not greater than 43% or not greater than 35% or not greater than 30% or not greater than 25% or not greater than 24% or not greater than 23% or not greater than 22% or not greater than 21% or not greater than 20%, or not greater than 19%, not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3%. In a further example, the coating can have a percent ratio of lithium/silicon within a range including any of the minimum and maximum values noted herein. It will be appreciated that all of the above ratios are applicable to the lithium and silicon elements and their compounds, including for example oxide compounds. For example, the coating can have a lithium oxide/silicon oxide (SiOx) percent ratio within a range including any of the minimum and maximum values noted above for the lithium/silicon percent ratio. The percent ratio of lithium/silicon is calculated by dividing the weight percentage of lithium in the coating by the weight percentage of silicon in the coating and then multiplying the calculated number by 100%. The weight percentages are those values obtained by ICP analysis of the coating as provided herein. For example, a coating including 0.9 wt % lithium and 90 wt % silicon would have a percent ratio of lithium/silicon of [(0.9 wt %/90 wt %)×100%)]=1%.

In an embodiment, the coating can have a particular content of lithium that can facilitate improved formation and properties of abrasive particle 200 or 210. In an aspect, the content of lithium in the coating may be at least 0.01 wt % for a total weight of the coating or at least 0.02 wt % or at least 0.03 wt % or at least 0.04 wt % or at least 0.05 wt % or at least 0.06 wt % or at least 0.07 wt % or at least 0.08 wt % or at least 0.09 wt % or at least 0.1 wt % or at least 0.15 wt % or at least 0.2 wt % or at least 0.23 wt % or at least 0.25 wt % or at least 0.3 wt % or at least 0.35 wt % or at least 0.4 wt % or at least 0.5 wt % or at least 0.6 wt % or at least 0.7 wt % or at least 0.8 wt % or at least 0.9 wt % or at least 1.0 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2.0 wt % or at least 2.1 wt % or at least 2.2 wt % or at least 2.3 wt % or at least 2.4 wt % or at least 2.5 wt % or at least 2.6 wt %. In still other embodiments, the lithium content may be not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt % or not greater than 1.8 wt % for the total weight of the coating. It will be appreciated that the coating can have a lithium content within a range including any of the minimum and maximum values noted herein. As will be appreciated, the weight percent of lithium is calculated according to the ICP analysis technique as described herein and the weight percent of lithium is intended to refer to the weight percent of lithium element.

In an embodiment, the coating can have a particular content of lithium-containing material that can facilitate improved formation and properties of abrasive particle 200 or 210. In an aspect, the content of lithium-containing material in the coating may be at least 0.01 wt % for a total weight of the coating or at least 0.02 wt % or at least 0.03 wt % or at least 0.04 wt % or at least 0.05 wt % or at least 0.06 wt % or at least 0.07 wt % or at least 0.08 wt % or at least 0.09 wt % or at least 0.1 wt % or at least 0.15 wt % or at least 0.2 wt % or at least 0.23 wt % or at least 0.25 wt % or at least 0.3 wt % or at least 0.35 wt % or at least 0.4 wt % or at least 0.5 wt % or at least 0.6 wt % or at least 0.7 wt % or at least 0.8 wt % or at least 0.9 wt % or at least 1.0 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2.0 wt % or at least 2.1 wt % or at least 2.2 wt % or at least 2.3 wt % or at least 2.4 wt % or at least 2.5 wt % or at least 2.6 wt % for the total weight of the coating. In still other embodiments, the lithium-containing material content may be not greater than 20 wt % for the total weight of the coating or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt % for the total weight of the coating. It will be appreciated that the coating can have a lithium-containing material content within a range including any of the minimum and maximum values noted herein. In a particular embodiment, the coating can have a particular content of lithium oxide and/or lithium silicate that can facilitate improved formation and properties of abrasive particle 200. For example, the contents of lithium-containing material noted in embodiments herein can be applied to lithium oxide and/or lithium silicate.

In still another embodiment, the coating can have a particular percent ratio of potassium content to a content of silicon that can facilitate improved formation and properties of abrasive particle 200 or 210. In an embodiment, the potassium may include a potassium-containing compound. In another aspect, the potassium-containing compound may include an oxide. In still another embodiment, the potassium-containing compound may include potassium oxide. In an embodiment, the silicon may include a silicon-containing compound. In another aspect, the silicon-containing compound may include an oxide. In still another embodiment, the silicon-containing compound may include silicon dioxide. In an aspect, the percent ratio of potassium/silicon is at least 0.01% or at least 0.02% at least 0.03% at least 0.04% at least 0.05% at least 0.06% at least 0.07% at least 0.08%, at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.1% or at least 3.2% or at least 3.4% or at least 3.6% or at least 3.8% or least 4.0%. In still other embodiments, the percent ratio of potassium/silicon percent ratio is not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20%, or not greater than 19%, not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 2% or not greater than 1% or not greater than 0.9% or not greater than 0.8% or not greater than 0.7% or not greater than 0.6% or not greater than 0.5% or not greater than 0.4%. In a further example, the coating can have a percent ratio of potassium/silicon within a range including any of the minimum and maximum values noted herein. It will be appreciated that all of the above ratios are applicable to the potassium and silicon elements and their compounds, including for example oxide compounds. For example, the coating can have a potassium oxide/silicon oxide (SiOx) percent ratio within a range including any of the minimum and maximum values noted above for the potassium/silicon percent ratio. The percent ratio of potassium/silicon is calculated by dividing the weight percentage of potassium in the coating by the weight percentage of silicon in the coating and then multiplying the calculated number by 100%. The weight percentages are those values obtained by ICP analysis of the coating as provided herein. For example, a coating including 0.9 wt % potassium and 90 wt % silicon would have a percent ratio of potassium/silicon of [(0.9 wt %/90 wt %)×100%)]=1%.

In another embodiment, the coating can have a particular content of silicon that can facilitate improved formation and properties of abrasive particle 200 or 210. In an aspect, the content of silicon is at least 21 wt % for a total weight of the coating, such as at least 25 wt % or at least 30 wt % or at least 32 wt % or at least 33 wt % or at least 35 wt % or at least 37 wt % or at least 38 wt % or at least 40 wt % or at least 41 wt % or at least 42 wt % or at least 43 wt % or at least 44 wt % or at least 45 wt % or at least 46 wt % or at least 48 wt % or at least 50 wt % or at least 52 wt % or at least 55 wt % or at least 60 wt % or at least 65 wt % or at least 70 wt % or at least 75 wt % or at least 80 wt % or at least 85 wt % or at least 90 wt % or at least 92 wt % or at least 95 wt % for a total weight of the coating, such as the first portion 202 of the coating. In still other non-limiting embodiments, the content of silicon may be not greater than 99 wt % or not greater than 98 wt % or not greater than 97 wt % or not greater than 96 wt % or not greater than 95 wt % or not greater than 93 wt % or not greater than 90 wt % or not greater than 88 wt % or not greater than 85 wt % or not greater than 83 wt % or not greater than 80 wt % or not greater than 77 wt % or not greater than 75 wt % or not greater than 72 wt % or not greater than 68 wt % or not greater than 64 wt % or not greater than 61 wt % or not greater than 58 wt % or not greater than 56 wt % or not greater than 54 wt % or not greater than 53 wt % or not greater than 51 wt % or not greater than 50 wt % or not greater than 49 wt % or not greater than 48 wt % or not greater than 46 wt % or not greater than 45 wt % or not greater than 44 wt % for a total weight of the coating. In a further example, the coating can have a content of silicon within a range including any of the minimum and maximum values noted herein. For example, the coating may include the content of silicon in a range including at least 21 wt % to not greater than 77 wt % or in a range including at least 33 wt % and not greater than 61 wt % or in a range including at least 38 wt % and not greater than 52 wt %. As will be appreciated, the weight percent of silicon is calculated according to the ICP analysis technique as described herein and intended to refer to the weight percent of silicon element.

In another embodiment, the coating can have a particular content of silicon-containing compound that can facilitate improved formation and properties of abrasive particle 200 or 210. In an aspect, the content of silicon-containing compound may be at least 21 wt % for a total weight of the coating, such as at least 25 wt % or at least 30 wt % or at least 32 wt % or at least 33 wt % or at least 35 wt % or at least 37 wt % or at least 38 wt % or at least 40 wt % or at least 41 wt % or at least 42 wt % or at least 43 wt % or at least 44 wt % or at least 45 wt % or at least 46 wt % or at least 48 wt % or at least 50 wt % or at least 52 wt % or at least 55 wt % or at least 60 wt % or at least 65 wt % or at least 70 wt % or at least 75 wt % or at least 80 wt % or at least 85 wt % or at least 90 wt % or at least 92 wt % or at least 95 wt % for a total weight of the coating, such as the first portion 202 of the coating. In still other non-limiting embodiments, the content of silicon-containing compound may be not greater than 99 wt % or not greater than 98 wt % or not greater than 97 wt % or not greater than 96 wt % or not greater than 95 wt % or not greater than 93 wt % or not greater than 90 wt % or not greater than 88 wt % or not greater than 85 wt % or not greater than 83 wt % or not greater than 80 wt % or not greater than 77 wt % or not greater than 75 wt % or not greater than 72 wt % or not greater than 68 wt % or not greater than 64 wt % or not greater than 61 wt % or not greater than 58 wt % or not greater than 56 wt % or not greater than 54 wt % or not greater than 53 wt % or not greater than 51 wt % or not greater than 50 wt % or not greater than 49 wt % or not greater than 48 wt % or not greater than 46 wt % or not greater than 45 wt % or not greater than 44 wt % for a total weight of the coating. In a further example, the coating can have a content of silicon-containing compound within a range including any of the minimum and maximum values noted herein. In another embodiment, the coating may include silicon oxide (SiOx) in any of the contents noted with respect to silicon-containing compound.

In another embodiment, the coating can have a particular content of oxygen that can facilitate improved formation and properties of abrasive particle 200 or 210. In an aspect, the content of oxygen may be at least 32 wt % or at least 33 wt % or at least 35 wt % or at least 37 wt % or at least 38 wt % or at least 40 wt % or at least 41 wt % or at least 42 wt % or at least 43 wt % or at least 44 wt % or at least 45 wt % or at least 46 wt % or at least 48 wt % or at least 50 wt % or at least 52 wt % or at least 55 wt % or at least 60 wt % or at least 65 wt % or at least 70 wt % or at least 75 wt % or at least 80 wt % or at least 85 wt % or at least 90 wt % or at least 92 wt % or at least 95 wt % for a total weight of the coating. In still other non-limiting embodiments, the content of oxygen may be not greater than 99 wt % or not greater than 98 wt % or not greater than 97 wt % or not greater than 96 wt % or not greater than 95 wt % or not greater than 93 wt % or not greater than 90 wt % or not greater than 88 wt % or not greater than 85 wt % or not greater than 83 wt % or not greater than 80 wt % or not greater than 77 wt % or not greater than 75 wt % or not greater than 72 wt % or not greater than 68 wt % or not greater than 64 wt % or not greater than 61 wt % or not greater than 58 wt % or not greater than 56 wt % or not greater than 54 wt % or not greater than 53 wt % or not greater than 51 wt % or not greater than 50 wt % or not greater than 49 wt % or not greater than 48 wt % or not greater than 46 wt % or not greater than 45 wt % or not greater than 44 wt % for a total weight of the coating. In a further example, the coating can have a content of oxygen within a range including any of the minimum and maximum values noted herein. For example, the coating may include the content of oxygen in a range including at least 21 wt % to not greater than 77 wt % or in a range including at least 33 wt % and not greater than 65 wt %. As will be appreciated, the weight percent of oxygen is calculated according to the ICP analysis technique as described herein and intended to refer to the weight percent of oxygen element. In another embodiment, the coating can have a particular content of potassium that can facilitate improved formation and properties of abrasive particle 200. In an aspect, the content of potassium may be at least 0.01 wt % or at least 0.02 wt % or at least 0.03 wt % or at least 0.04 wt % or at least 0.05 wt % or at least 0.06 wt % or at least 0.07 wt % or at least 0.08 wt % or at least 0.09 wt % or at least 1 wt % for a total weight of the coating, such as at least 2 wt % or at least 3 wt % or at least 4 wt % or at least 5 wt % or at least 6 wt % or at least 7 wt % or at least 8 wt % or at least 9 wt % or at least 10 wt %. In still other embodiments, the content of potassium may be not greater than 30 wt % not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt % or not greater than 1 wt % or not greater than 0.9 wt % or not greater than 0.8 wt % or not greater than 0.7 wt % or not greater than 0.6 wt % or not greater than 0.5 wt % or not greater than 0.4 wt % or not greater than 0.3 wt % or not greater than 0.2 wt % or not greater than 0.1 wt % or not greater than 0.05 wt % for a total weight of the coating. In a further example, the coating can have a content of potassium within a range including any of the minimum and maximum values noted herein. In at least one particular embodiment, the coating may be essentially free of potassium. In yet another particular embodiment, potassium may be an unavoidable impurity present in the coating. For instance, potassium in the coating may be due to the use of a starting material that contains an impurity including a potassium-containing material. As will be appreciated, the weight percent of potassium is calculated according to the ICP analysis technique as described herein and intended to refer to the weight percent of potassium element.

In still another embodiment, the coating can have a particular percent ratio of sodium content to a content of silicon that can facilitate improved formation and properties of abrasive particle 200. In an embodiment, the sodium may include a sodium-containing compound. In another aspect, the sodium-containing compound may include an oxide. In still another embodiment, the sodium-containing compound may include sodium oxide. In an embodiment, the silicon may include a silicon-containing compound. In another aspect, the silicon-containing compound may include an oxide. In still another embodiment, the silicon-containing compound may include silicon dioxide. In an aspect, the percent ratio of sodium/silicon may be at least 0.01% or at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0% or at least 4.2% or at least 4.4% or at least 4.6% or at least 4.8% or at least 5.0% or at least 5.2% or at least 5.4% or at least 5.5%. In still other embodiments, the percent ratio of sodium/silicon percent ratio may be not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20%, or not greater than 19%, not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2.5% or not greater than 2.3% or not greater than 2% or not greater than 1% or not greater than 0.5%. In a further example, the coating can have a percent ratio of sodium/silicon within a range including any of the minimum and maximum values noted herein. It will be appreciated that all of the above ratios are applicable to the sodium and silicon elements and their compounds, including for example oxide compounds. For example, the coating can have a sodium oxide/silicon oxide (SiOx) percent ratio within a range including any of the minimum and maximum values noted above for the sodium/silicon percent ratio. The percent ratio of sodium/silicon is calculated by dividing the weight percentage of sodium in the coating by the weight percentage of silicon in the coating and then multiplying the calculated number by 100%. The weight percentages are those values obtained by ICP analysis of the coating as provided herein. For example, a coating including 0.9 wt % sodium and 90 wt % silicon would have a percent ratio of sodium/silicon of [(0.9 wt %/90 wt %)×100%)]=1%.

In another embodiment, the coating can have a particular content of sodium that can facilitate improved formation and properties of abrasive particle 200. In an aspect, the content of sodium may be at least 0.1 wt % for a total weight of the coating, such as at least 0.2 wt % or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.5 wt % or at least 2 wt % at least 3 wt % or at least 4 wt % or at least 5 wt % or at least 6 wt % or at least 7 wt % or at least 8 wt % or at least 9 wt % or at least 10 wt %. In still other embodiments, the content of sodium may be not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 8 wt % or not greater than 6 wt % or not greater than 4 wt % or not greater than 2.5 wt % or not greater than 2 wt % or not greater than 1.5 wt % or not greater than 1.2 wt % or not greater than 1 wt % for a total weight of the coating. In a further example, the coating can have a content of sodium within a range including any of the minimum and maximum values noted herein. In another example, the coating can include a content of sodium in a range including at least 0.1 wt % and not greater than 16 wt % or in a range including at least 0.3 wt % and not greater than 9 wt % or in a range including at least 0.5 wt % and not greater than 1.2 wt %. In at least one particular embodiment, sodium may be present in an impurity included in the coating. For instance, a sodium-containing material may be an unavoidable impurity contained in a starting material and result in the presence of sodium in the coating. In one particular embodiment, the coating may be essentially free of sodium. In another particular embodiment, the coating may be essentially free of sodium. As will be appreciated, the weight percent of sodium is calculated according to the ICP analysis technique as described herein and intended to refer to the weight percent of sodium element.

According to another non-limiting embodiment, the coating can have a particular percent ratio of sodium content to a content of lithium that can facilitate improved formation and properties of abrasive particle 200. In an aspect, the percent ratio of sodium/lithium is at least 0.01% or at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0% or at least 6% or at least 8% or at least at least 10% or at least 13% or at least 16% or at least 20% or at least 24% or at least 28% or at least 31% or at least 35% or at least 39% or at least 43% or at least 45% or at least 47% or at least 48% or at least 50% or at least 52% or at least 54% or at least 56% or least 58% or at least 61%. In still other embodiments, the percent ratio of sodium/lithium percent ratio is not greater than 600% or not greater than 550% or not greater than 530% or not greater than 510% or not greater than 490% or not greater than 470% or not greater than 450% or not greater than 430% or not greater than 420% or not greater than 400% or not greater than 350% or not greater than 320% or not greater than 300% or not greater than 250% or not greater than 200% or not greater than 100% or not greater than 90% or not greater than 80% or not greater than 70% or not greater than 60% or not greater than 50% or not greater than 40% or not greater than 30% or not greater than 20% or not greater than 15% or not greater than 10% or not greater than 9% or not greater than 8% or not greater than 7% or not greater than 6% or not greater than 5% or not greater than 4%. In a further example, the coating can have a percent ratio of sodium/silicon within a range including any of the minimum and maximum values noted herein. In a particular example, the coating can have a percent ratio of sodium/silicon within a range including at least 4.0% and not greater than 600% or within a range including at least 35% and not greater than 500% or within a range including at least 47% and not greater than 420%. The percent ratio of sodium/lithium is calculated by dividing the weight percentage of sodium in the coating by the weight percentage of lithium in the coating and then multiplying the calculated number by 100%. The weight percentages are those values obtained by ICP analysis of the coating as provided herein. For example, a coating including 0.9 wt % sodium and 90 wt % lithium would have a percent ratio of sodium/lithium of [(0.9 wt %/90 wt %)×100%)]=1%.

According to another non-limiting embodiment, the coating can have a particular percent ratio of sodium content to a content of potassium that can facilitate improved formation and properties of abrasive particle 200. In an aspect, the percent ratio of sodium/potassium is at least 0.01% or at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0% or at least 5.0% or at least 8.0% or at least 10% or at least 20% or at least 30% or at least 40% or at least 50% or at least 60% or at least 70% or at least 80%. In still other embodiments, the percent ratio of sodium/potassium percent ratio is not greater than 200% or not greater than 190% or not greater than 180% or not greater than 170% or not greater than 60% or not greater than 150% or not greater than 140% or not greater than 130% or not greater than 120% or not greater than 110% or not greater than 100% or not greater than 90% or not greater than 80% or not greater than 70% or not greater than 60% or not greater than 50% or not greater than 40% or not greater than 30% or not greater than 20% or not greater than 15% or not greater than 10% or not greater than 9% or not greater than 8% or not greater than 7% or not greater than 6% or not greater than 5% or not greater than 4%. In a further example, the coating can have a percent ratio of sodium/potassium within a range including any of the minimum and maximum values noted herein. The percent ratio of sodium/potassium is calculated by dividing the weight percentage of sodium in the coating by the weight percentage of potassium in the coating and then multiplying the calculated number by 100%. The weight percentages are those values obtained by ICP analysis of the coating as provided herein. For example, a coating including 0.9 wt % sodium and 90 wt % potassium would have a percent ratio of sodium/potassium of [(0.9 wt %/90 wt %)×100%)]=1%.

According to another non-limiting embodiment, the coating can have a particular percent ratio of potassium content to a content of lithium that can facilitate improved formation and properties of abrasive particle 200. In an aspect, the percent ratio of potassium/lithium is at least 0.01% or at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0% or at least 5.0% or at least 8.0% or at least 10% or at least 20% or at least 30% or at least 40% or at least 50% or at least 60% or at least 70% or at least 80%. In still other embodiments, the percent ratio of potassium/lithium percent ratio is not greater than 200% or not greater than 190% or not greater than 180% or not greater than 170% or not greater than 60% or not greater than 150% or not greater than 140% or not greater than 130% or not greater than 120% or not greater than 110% or not greater than 100% or not greater than 90% or not greater than 80% or not greater than 70% or not greater than 60% or not greater than 50% or not greater than 40% or not greater than 30% or not greater than 20% or not greater than 15% or not greater than 10% or not greater than 9% or not greater than 8% or not greater than 7% or not greater than 6% or not greater than 5% or not greater than 4%. In a further example, the coating can have a percent ratio of potassium/lithium within a range including any of the minimum and maximum values noted herein. The percent ratio of potassium/lithium is calculated by dividing the weight percentage of potassium in the coating by the weight percentage of lithium in the coating and then multiplying the calculated number by 100%. The weight percentages are those values obtained by ICP analysis of the coating as provided herein. For example, a coating including 0.9 wt % potassium and 90 wt % lithium would have a percent ratio of potassium/lithium of [(0.9 wt %/90 wt %)×100%)]=1%.

In still other embodiments, the coating can have a particular content of sodium compared to a lithium content that can facilitate improved formation and properties of abrasive particle 200. In an aspect, the coating comprises a sodium content that is not greater than 10 times the lithium content as measured in wt % via the ICP analysis technique described herein, or wherein the coating comprises a sodium content that is not greater than 8 times the lithium content, or wherein the coating comprises a sodium content that is not greater than 6 times the lithium content, or wherein the coating comprises a sodium content that is not greater than 4 times the lithium content, or wherein the coating comprises a sodium content that is not greater than 3 times the lithium content, or wherein the coating comprises a sodium content that is not greater than 2.8 times the lithium content, or wherein the coating comprises a sodium content that is not greater than 2.5 times the lithium content, or wherein the coating comprises a sodium content that is not greater than 2.2 times the lithium content, or wherein the coating comprises a sodium content that is not greater than 2 times the lithium content, or wherein the coating comprises a sodium content that is not greater than 1.8 times the lithium content, or wherein the coating comprises a sodium content that is not greater than 1.5 times the lithium content or wherein the coating comprises a sodium content that is not greater than 1.3 times the lithium content or wherein the coating comprises a sodium content that is not greater than 0.9 times the lithium content or wherein the coating comprises a sodium content that is not greater than 0.6 times the lithium content or wherein the coating comprises a sodium content that is not greater than 0.3 times the lithium content or wherein the coating comprises a sodium content that is not greater than 0.2 times the lithium content or wherein the coating comprises a sodium content that is not greater than 0.1 times the lithium content or wherein the coating comprises a sodium content that is not greater than 0.05 times the lithium content or wherein the coating comprises a sodium content that is not greater than 0.01 times the lithium content.

In still other embodiments, the coating can have a particular content of sodium compared to a potassium content that can facilitate improved formation and properties of abrasive particle 200. In an aspect, the coating comprises a sodium content that is not greater than 10 times the potassium content as measured in wt % via the ICP analysis technique described herein, or wherein the coating comprises a sodium content that is not greater than 8 times the potassium content, or wherein the coating comprises a sodium content that is not greater than 6 times the potassium content, or wherein the coating comprises a sodium content that is not greater than 4 times the potassium content, or wherein the coating comprises a sodium content that is not greater than 3 times the potassium content, or wherein the coating comprises a sodium content that is not greater than 2.8 times the potassium content, or wherein the coating comprises a sodium content that is not greater than 2.5 times the potassium content, or wherein the coating comprises a sodium content that is not greater than 2.2 times the potassium content, or wherein the coating comprises a sodium content that is not greater than 2 times the potassium content, or wherein the coating comprises a sodium content that is not greater than 1.8 times the potassium content, or wherein the coating comprises a sodium content that is not greater than 1.5 times the potassium content or wherein the coating comprises a sodium content that is not greater than 1.3 times the potassium content or wherein the coating comprises a sodium content that is not greater than 0.9 times the potassium content or wherein the coating comprises a sodium content that is not greater than 0.6 times the potassium content or wherein the coating comprises a sodium content that is not greater than 0.3 times the potassium content or wherein the coating comprises a sodium content that is not greater than 0.2 times the potassium content or wherein the coating comprises a sodium content that is not greater than 0.1 times the potassium content or wherein the coating comprises a sodium content that is not greater than 0.05 times the potassium content or wherein the coating comprises a sodium content that is not greater than 0.01 times the potassium content.

In another embodiment, the coating can have a particular content of a silicate-containing compound that can facilitate improved formation and properties of abrasive particle 200. In a particular embodiment, the silicate-containing compound can include potassium silicate, sodium silicate, lithium silicate or a combination thereof. In an aspect, the content of silicate-containing compound is at least 1 wt % for a total weight of the coating or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt %. In still other embodiments, the content of silicate-containing compound is not greater than 99 wt % for a total weight of the coating or not greater than 95 wt % or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt % for a total weight of the coating. In a further example, the coating can have a content of silicate-containing compound within a range including any of the minimum and maximum values noted herein. As will be appreciated, the weight percent of silicate-containing compound is calculated according to the ICP analysis technique as described herein.

In another embodiment, the coating can have a particular content of a silica-containing compound that can facilitate improved formation and properties of abrasive particle 200. In a particular embodiment, the silica-containing compound can include silicon dioxide or a combination thereof. In an aspect, the content of silica-containing compound is at least 1 wt % for a total weight of the coating or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt %. In still other embodiments, the content of silica-containing compound is not greater than 99 wt % for a total weight of the coating or not greater than 95 wt % or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt % for a total weight of the coating. In a further example, the coating can have a content of silica-containing compound within a range including any of the minimum and maximum values noted herein. As will be appreciated, the weight percent of silica-containing compound is calculated according to the ICP analysis technique as described herein.

According to another non-limiting embodiment, the coating can have a particular percent ratio of silicate content to a content of silica that can facilitate improved formation and properties of abrasive particle 200. In an aspect, the percent ratio of silicate/silica is at least 10% or at least or at least 15% or at least 20% or at least 25% or at least 30% or at least 35% or at least 40% or at least 45% at least 50% or at least 60% or at least 70% or at least 80% or at least 90% or at least 100%. In still other embodiments, the percent ratio of silicate/silica percent ratio is not greater than not greater than 1000% or not greater than 900% or not greater than 800% or not greater than 700% or not greater than 600% or not greater than 500% or not greater than 400% or not greater than 300% 200% or not greater than 190% or not greater than 180% or not greater than 170% or not greater than 60% or not greater than 150% or not greater than 140% or not greater than 130% or not greater than 120% or not greater than 110% or not greater than 100% or not greater than 90% or not greater than 80% or not greater than 70% or not greater than 60% or not greater than 50% or not greater than 40% or not greater than 30% or not greater than 20% or not greater than 15% or not greater than 10% or not greater than 9% or not greater than 8% or not greater than 7% or not greater than 6% or not greater than 5% or not greater than 4%. In a further example, the coating can have a percent ratio of silicate/silica within a range including any of the minimum and maximum values noted herein. The percent ratio of silicate/silica is calculated by dividing the weight percentage of silicate-containing compound in the coating by the weight percentage of silica-containing compound in the coating and then multiplying the calculated number by 100%. The weight percentages are those values obtained by ICP analysis of the coating as provided herein. For example, a coating including 0.9 wt % silicate-containing compound and 90 wt % silica-containing compound would have a percent ratio of silicate/silica of [(0.9 wt %/90 wt %)×100%)]=1%.

In an embodiment, the abrasive particles 200 can have an average coating coverage of the surface of the core 201 that can facilitate improved property and performance of the abrasive particles. In an aspect, the average coating coverage can be at least 50% of the entire surface of the core, at least 55%, at least 57%, at least 59%, at least 61%, at least 63%, at least 65%, at least 68%, at least 70%, at least 72%, at least 75%, at least 76%, at least 77%, at least 79%, at least 80%, at least 82%, at least 84%, at least 85%, at least 87%, at least 88%, at least 90%, at least 91%, at least 92%, at least 93%, at least 94%, at least 95%, at least 96%, at least 97%, and at least 98%, at least 99%, and not greater than 100% of the entire surface of the core 201.

In an embodiment, the abrasive particle may include a coating including alkali metal element including lithium, silicon, oxygen, or any combination thereof. In a particular embodiment, the coating may include a higher content of silicon than lithium. In another particular embodiment, the coating may include a higher content of oxygen than lithium. In still another particular embodiment, the coating may include lithium, silicon, and oxygen. For example, the coating may include a lithium-containing material. In a more particular example, the coating may include a lithium-containing material including at least one of silicon and oxygen. In an even more particular example, the coating may include a lithium-containing material including silicon and oxygen.

The coating coverage can be determined by Energy Dispersive Spectroscopy (EDS) analysis. Image acquisition of abrasive particles can be conducted by using Merlin™ field emission scanning electron microscopy (FESEM) from Zeiss with suitable imaging parameters and Fast Acquisition in Bruker software. For instance, parameters of 7 kV, 300 pA, and up to 10 mm WD can be used for imaging. Abrasive particle can be coated with Au/Pd for 30 seconds prior to image acquisition. Using EDS, elements of the abrasive particles can be quantified and used as an indication whether a point of the core is covered by the first portion. 1% of Si can be used as threshold of 1% Si, and the quantitative chemical analysis for each point can be reduced to a binomial (covered or not). Quantity of the Au/Pd coating and C element is not considered in the analysis. A 95% confidence interval (95% CI) can be used on a binomial distribution calculator, such as Binomial Probability Confidence Interval Calculator (version 4.0) available at www.dianelsoper.com, to calculate the reported confidence intervals. For example, when 53 out of 60 points demonstrate greater than 1% of Si, the trial number to input to the calculator is 60 and successes 53. At 95% CI, the coverage is 77% to 95%.

In another embodiment, the coating 202 can have a substantially uniform thickness. In one embodiment, thickness of the coating 202 may change along the surface of the core 201.

In another embodiment, abrasive particles 200 may include an average thickness of the coating 202 that can facilitate improved formation and properties of the abrasive particles. For instance, the average thickness of the coating 202 can be at least 10 nm, at least 12 nm, at least 15 nm, at least 18 nm, at least 20 nm, at least 25 nm, at least 28 nm, at least 30 nm, at least 32 nm, at least 35 nm, at least 38 nm, at least 40 nm, at least 43 nm, at least 45 nm, at least 48 nm, at least 50 nm, at least 52 nm, at least 55 nm, at least 58 nm, at least 60 nm, at least 63 nm, at least 68 nm, at least 70 nm, at least 74 nm, at least 76 nm, at least 80 nm, at least 83 nm, at least 86 nm, at least 90 nm. In another instance, the average thickness of the coating 202 of the abrasive particles 200 may be not greater than 150 nm, not greater than 140 nm, not greater than 130 nm, not greater than 120 nm, not greater than 110 nm, not greater than 100 nm. Moreover, the average thickness of the coating 202 of the abrasive particles 200 can be in a range including any of the minimum and maximum values noted herein. For example, the abrasive particles can include an average thickness of the coating 202 in a range from 10 nm to 150 nm, or in a range from 80 nm to 100 nm.

In a further embodiment, the abrasive particles 200 can include a particular thickness standard deviation of the coating 202 that can facilitate improved formation of the abrasive particles and improved performance of the abrasive particles. In an aspect, an absolute value of the thickness standard deviation may be not greater than 200% of the average thickness, not greater than 150%, not greater than 100%, not greater than 80%, not greater than 50%, not greater than 49%, not greater than 47%, not greater than 44%, not greater than 42%, not greater than 40%, not greater than 38%, not greater than 36%, not greater than 34%, not greater than 33%, not greater than 31%, not greater than 30%, not greater than 29%, not greater than 27%, not greater than 25%, not greater than 23%, not greater than 21%, not greater than 20%, not greater than 19%, not greater than 18%, not greater than 17%, not greater than 16%, not greater than 14%, not greater than 12%, not greater than 11%, not greater than 10%, not greater than 9%, not greater than 8%, not greater than 7%, not greater than 6%, not greater than 5%, not greater than 4%, not greater than 3%, not greater than 2%, not greater than 1%, not greater than 0.8%, not greater than 0.7%, or not greater than 0.5% of the average thickness of the coating. In another aspect, the abrasive particles can include an absolute value of the thickness standard deviation of at least 0.001% of the average thickness, at least 0.05%, at least 0.08%, at least 0.1%, at least 0.2%, at least 0.3%, at least 0.4%, at least 0.5%, at least 0.7%, at least 0.8%, at least 0.9%, at least 1%, at least 1.2%, at least 1.5%, at least 1.8%, at least 2%, at least 2.2%, at least 2.5%, at least 2.8%, at least 3%, at least 4%, or at least 5% of the average thickness of the coating. Moreover, the abrasive particles can include a thickness standard deviation of the coating having an absolute value in a range including any of the minimum and maximum values noted therein.

In a further aspect, the abrasive particle can include a thickness standard deviation of the coating 202 of at least 1 nm, at least 3 nm, at least 5 nm, at least 7 nm, at least 9 nm, at least 10 nm, at least 13 nm, at least 15 nm, at least 17 nm, at least 19 nm, at least 21 nm, at least 23 nm, at least 25 nm, at least 28 nm, at least 30 nm, at least 32 nm, at least 34 nm, at least 36 nm, at least 39 nm, at least 41 nm, at least 45 nm, at least 46 nm, at least 48 nm, or at least 50 nm, at least 60 nm, at least 70 nm, at least 80 nm, at least 100 nm, at least 110 nm, at least 120 nm, at least at least 130 nm, at least 140 nm, at least 150 nm, at least 160 nm, at least 170 nm, at least 180 nm, at least 190 nm, at least 210 nm, at least 220 nm, or at least 230 nm, at least 240 nm, at least 250 nm, at least 260 nm, at least 270 nm, or at least 280 nm. In another aspect, the thickness standard deviation may be not greater than 500 nm, not greater than 480 nm, not greater than 460 nm, not greater than 420 nm, not greater than 400 nm, not greater than 350 nm, not greater than 320 nm, not greater than 310 nm, not greater than 300 nm, not greater than 280 nm, not greater than 260 nm, not greater than 230 nm, not greater than 210 nm, not greater than 190 nm, not greater than 170 nm, not greater than 150 nm, not greater than 130 nm, not greater than 120 nm, not greater than 110 nm, not greater than 100 nm, not greater than 90 nm, not greater than 80 nm, not greater than 70 nm, not greater than 60 nm, not greater than 50 nm, not greater than 40 nm, not greater than 30 nm, not greater than 20 nm, not greater than 18 nm, not greater than 15 nm, not greater than 12 nm, not greater than 10 nm, or not greater than 5 nm. Moreover, the thickness standard deviation of the coating can be in a range including any of the minimum and maximum values noted herein. In a particular instance, the thickness standard deviation of the coating can be in a range from 10 nm to 400 nm, or in a range from 30 nm to 300 nm, or in a range from 50 nm to 200 nm.

In an embodiment, the coating 202 can include an amorphous phase including silica. In another particular aspect, the coating 202 can include a particular amount of amorphous phase that can facilitate improved formation and property of the abrasive grains 210 and abrasive articles including the abrasive grains 210. For example, at least 90 vol %, or at least 95 vol % of the coating 202 can be an amorphous phase. In a further particular aspect, the coating 202 consists essentially of an amorphous phase.

In another aspect, the coating 202 can include silica in an amorphous phase and in a crystalline phase. In another particular aspect, the coating 202 can include an amorphous phase consisting essentially of silica and a crystalline phase consisting essentially of silica.

In an aspect, the coating, and in particular, the first portion 202 of the coating may have a particular crystalline content that may improve the manufacturing and/or performance of the abrasive particles and/or a fixed abrasive article including such abrasive particles. For example, the coating may have a particular crystalline content (i.e., monocrystalline or polycrystalline), including for example, but not limited to a crystalline content of at least 1 vol % of the total volume of the first portion 202, such as at least 3 vol % or at least 5 vol % or at least 7 vol % or at least 10 vol % or at least 12 vol % or at least 15 vol % of a total volume of the coating, and in particular, the first portion 202. In a non-limiting embodiment, the total crystalline content of the coating, such as the first portion 202 may be limited due to a lack of high temperature sintering. For example, in one non-limiting embodiment, the coating, such as the first portion 202 may have a total crystalline content of not greater than 99 vol % of the total volume of the coating or the first portion 202 of the coating, such as not greater than 97 vol % or not greater than 90 vol % or not greater than 80 vol % or not greater than 70 vol % or not greater than 60 vol % or not greater than 50 vol % or not greater than 40 vol % or not greater than 30 vol % or not greater 20 vol % or not greater than 10 vol % or not greater than 8 vol % or not greater than 5 vol % or not greater than 3 vol % or not greater than 2 vol % of the total volume of the coating, and in particular, a first portion 202 of the coating may have a total crystalline content of not greater than 1 vol % of the total volume of the coating. Moreover, the coating 202 can include a crystalline content within a range including any of the minimum and maximum percentages noted herein. In one particular embodiment, the first portion 202 of the coating may be essentially free of crystalline phases.

In another particular embodiment, the coating, such as the first portion 202 of the coating may include a majority content of amorphous phase for a total volume of the first portion, such as at least 55 vol % amorphous phase for a total volume of the first portion 202, such as at least 60 vol % or at least 70 vol % or at least 80 vol % or at least 90 vol % or at least 95 vol % amorphous content for a total volume of the first portion 202 of the coating of the abrasive particles. In one particular instance, the first portion 202 may consist essentially of amorphous phase materials. For example, in one particular embodiment, the first portion 202 may include a mixture of amorphous phase silicon dioxide and amorphous phase silicate(s).

Crystallinity can be determined by performing X-ray diffraction (also referred to as “XRD” in this disclosure) analysis on a powder sample of the coating 202 prepared as follows. The first material can be disposed in an alumina crucible and heated in a furnace at sintering temperature noted in embodiments herein for 30 min. Then the crucibles can be taken out of the furnace and left to cool down at ambient temperature (i.e., 20° C. to 25° C.). The solids can be recovered from the crucibles and milled manually, such as using mortar and pestle, to obtain the powder sample of the coating 202. XRD can be acquired in Bragg-Brentano configuration (standard for powder XRD) using a copper X-ray source having Cu K alpha wavelength of 1.54 Angstrom. Identification of crystalline phase can be performed using the EVA Bruker AXS software or another equivalent software, and the ICDD-PDF4+ database (Release 2020). Crystallinity can be determined by Rietveld refinement using the TOPAS 4.2 software from Bruker or another equivalent software following the Corindon Al₂O₃ standard.

In an embodiment, the first portion of the coating can include domains having a particular average domain size that can facilitate improved formation and performance of the abrasive particles.

In another embodiment, the coating may include nanoparticles, a binder material, or a combination thereof. In a particular embodiment, the coating may include agglomerated particles including nanoparticles bonded via a binder material. In an aspect, the binder material may include silicon and oxygen. In a particular aspect, the binder material may include a silicate, such as a silicate including one or more alkali metal. In a particular example, the binder material may include a silicate including lithium and optionally another alkali metal, such as sodium, potassium, or any combination thereof. In an even more particular example, the binder material may consist essentially of lithium silicate. In another aspect, the nanoparticles may include silicon and oxygen. In a particular aspect, the nanoparticles may include silica.

In another embodiment, the coating may include nanopores, such as pores having pore sizes not greater than 800 nm, not greater than 700 nm, not greater than 600 nm, not greater than 500 nm, not greater than 400 nm, not greater than 300 nm, not greater than 200 nm, not greater than 100 nm, not greater than 90 nm, not greater than 80 nm, not greater than 70 nm, not greater than 60 nm, not greater than 50 nm, not greater than 40 nm, not greater than 30 nm, not greater than 20 nm, not greater than 10 nm, not greater than 8 nm, or not greater than 6 nm. Additionally or alternatively, the coating may include pores having pore sizes of at least 1 nm, at least 5 nm, at least 7 nm, at least 10 nm, at least 20 nm, at least 30 nm, at least 40 nm, at least 50 nm, at least 60 nm, at least 70 nm, at least 80 nm, at least 90 nm, at least 100 nm, at least 200 nm, or at least 30 nm. Moreover, the coating may include pores having sizes within a range including any of the minimum and maximum values noted herein.

In another embodiment, the coating may include pores in a particular content, such as at least 0.0001 vol % for a total volume of an abrasive particle, or at least 0.0005 vol %, at least 0.001 vol %, at least 0.005 vol %, at least 0.01 vol %, at least 0.05 vol %, at least 0.1 vol %, at least 0.5 vol %, or at least 1 vol % for a total volume of an abrasive particle. Additionally or alternatively, the coating may include not greater than 10 vol % of pores for a total volume of an abrasive particle, not greater than 9 vol %, not greater than 8 vol %, not greater than 7 vol %, not greater than 6 vol %, not greater than 5 vol %, not greater than 4 vol %, not greater than 3 vol %, not greater than 2 vol %, not greater than 1 vol %, not greater than 0.5 vol %, not greater than 0.1 vol %, not greater than 0.05 vol %, not greater than 0.01 vol %, or not greater than 0.005 vol % for a total volume of an abrasive particle. Moreover, the coating may include a content of pores in a range including any of the minimum and maximum percentages noted herein.

In another embodiment, the coating may include a density of at least 51% of theoretical density, such as at least 55%, at least 60%, at least 65%, at least 70%, at least 75%, at least 80%, at least 85%, or at least 90% of theoretical density. Additionally or alternatively, the coating may include a density of not greater than 98% of theoretical density, such as not greater than 95%, not greater than 93%, not greater than 90%, or not greater than 88% of theoretical density. Moreover, the coating may include a density in a range including any of the minimum and maximum percentages noted herein. In a further embodiment, the core may include a higher density than the coating.

In an embodiment, the coating may include a particular roughness that may facilitate improved property and/or performance of the abrasive particles.

In another embodiment, the coating may include a particular coverage over the core that may facilitate improved property and/or performance of the abrasive particles. In an example, the coating coverage may be at least 75% of the surface area of the core, such as at least 80%, at least 85%, at least 90%, or at least 93% of the surface area of the core. In another example, the coating coverage may be not greater than 99% of the surface area of the core, such as greater than 97%, not greater than 95%, not greater than 93%, not greater than 90%, or not greater than 88% of the surface area of the core. Moreover, the coating coverage may be in a range including any of the minimum and maximum percentages noted herein.

In an embodiment, the coating may include a particular average number of discrete nanoparticles (loose nanoparticles) per a certain area that may facilitate improved property and/or performance of the abrasive particles.

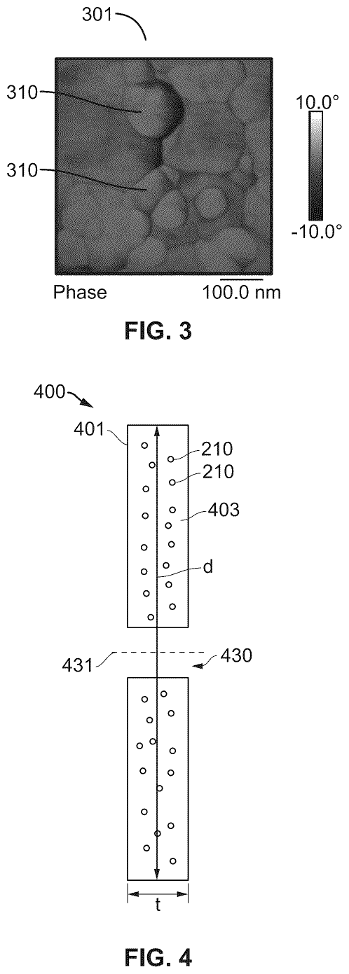

FIG. 3 includes atomic force microscopic (also referred to as “AFM” in this disclosure) phase images of abrasive particle. FIG. 3 includes an image of the core 301 including crystallites 310.

In an embodiment, the abrasive particles can include an average domain size of at least 50 nm, at least 55 nm, at least 60 nm, at least 65 nm, at least 70 nm, at least 75 nm, at least 80 nm, at least 90 nm, at least 100 nm, at least 200 nm, at least 300 nm, at least 400 nm, at least 500 nm, or at least 600 In another aspect, the abrasive particles may include an average domain size of the coating of greater than nm or greater than 26 nm. In particular aspect, the abrasive particles can include an average domain size of not greater than 3 mm, not greater than 2 mm, not greater than 1 mm, not greater than 0.5 mm, not greater than 0.1 mm, not greater than 0.01 mm or not greater than 0.001 mm. Moreover, the abrasive particles can include an average domain size including any of the minimum and maximum values noted herein. As used herein, average domain size is intended to refer to the average value of the largest dimensions of at least 20 identifiable domains in the phase images of randomly selected abrasive particles. The domain size of the abrasive particles was measured by scanning electron microscopy (SEM) of a polished section of abrasive particles. Magnification of 50,000× was used, and specimens were thermally etched for 5 minutes at 100° C. The domain size was obtained by the intercept method without statistical correction.

In an embodiment, the abrasive particles can include a particular standard deviation of the domain size that can facilitate improved formation and performance of the abrasive particles. In an aspect, the standard deviation of the domain size can have an absolute value of not greater than 50% of the average domain size, not greater than 49%, not greater than 48%, not greater than 47%, not greater than 46%, not greater than 45%, not greater than 44%, not greater than 43%, not greater than 42%, not greater than 41%, not greater than 40%, not greater than 39%, not greater than 38%, not greater than 37%, not greater than 36%, not greater than 35%, not greater than 33%, not greater than 31%, not greater than 30%, not greater than 29%, not greater than 27%, not greater than 25%, not greater than 23%, not greater than 21%, not greater than 20%, not greater than 19%, not greater than 17%, not greater than 16%, not greater than 15%, not greater than 49%, not greater than 48%, not greater than 47%, not greater than 46%, not greater than 45%, not greater than 43%, not greater than 42%, not greater than 41%, not greater than 40%, not greater than 39%, not greater than 37%, not greater than 35%, not greater than 33%, not greater than 30%, not greater than 28%, not greater than 26%, not greater than 24%, not greater than 21%, not greater than 19%, not greater than 17%, not greater than 15%, not greater than 13%, not greater than 11%, not greater than 10%, not greater than 9%, not greater than 8%, not greater than 7%, or not greater than 5% of the average domain size of the coating. In another aspect, the abrasive particles can include a standard deviation of the domain size having an absolute value of at least 0.001% of the domain size of the coating, at least 0.01%, at least 0.1%, at least 1%, at least 2%, at least 4%, at least 3%, or at least 5% of the domain size of the coating. Moreover, the abrasive particles can include a standard deviation having an absolute value in a range including any of the minimum and maximum values noted herein.

In another embodiment, the abrasive particles can include a standard deviation having an absolute value of not greater than 65 nm, not greater than 63 nm, not greater than 61 nm, not greater than 60 nm, not greater than 58 nm, not greater than 55 nm, not greater than 53 nm, not greater than 51 nm, not greater than 50 nm, not greater than 49 nm, not greater than 47 nm, not greater than 45 nm, not greater than 43 nm, not greater than 41 nm, not greater than 40 nm, not greater than 38 nm, not greater than 36 nm, not greater than 32 nm, not greater than 30 nm, not greater than 28 nm, not greater than 25 nm, not greater than 23 nm, not greater than 22 nm, not greater than 20 nm, not greater than 19 nm, not greater than 17 nm, not greater than 16 nm, not greater than 15 nm, not greater than 14 nm, not greater than 13 nm, or not greater than 12 nm. In another aspect, the abrasive particles can include a standard deviation of the domain size having an absolute value of at least 0.1 nm, at least 0.3 nm, at least 0.5 nm, at least 1 nm, at least 2 nm, at least 3 nm, at least 4 nm, at least 5 nm, at least 6 nm, at least 7 nm, at least 8 nm, at least 9 nm, at least 10 nm, at least 11 nm, at least 12 nm, at least 13 nm, at least 14 nm, at least 15 nm, at least 16 nm, or at least 17 nm. Moreover, the standard deviation can have an absolute value in a range including any of the minimum and maximum values noted herein.

In a further embodiment, the abrasive particle (i.e., 200 or 210 illustrated in FIGS. 2A and 2B respectively) may include a particular specific surface area that may facilitate improved properties and performance of abrasive articles. For example, the abrasive particle may include a specific surface area of greater than 0.05 m²/g, such as at least 0.10 m²/g, at least 0.15 m²/g, at least 0.17 m²/g, at least 0.19 m²/g, at least 0.21 m²/g, at least 0.23 m²/g, at least 0.25 m²/g, at least 0.26 m²/g, at least 0.28 m²/g, at least 0.29 m²/g, at least 0.31 m²/g, at least 0.32 m²/g, at least 0.33 m²/g, at least 0.35 m²/g, at least 0.37 m²/g, at least 0.38 m²/g, at least 0.39 m²/g, at least 0.4 m²/g, at least 0.42 m²/g, at least 0.44 m²/g, at least 0.45 m²/g, at least 0.46 m²/g, at least 0.48 m²/g, at least 0.5 m²/g, at least 0.52 m²/g, at least 0.54 m²/g, at least 0.55 m²/g, at least 0.56 m²/g, at least 0.58 m²/g, at least 0.59 m²/g, at least 0.61 m²/g, at least 0.63 m²/g, at least 0.64 m²/g, or at least 0.66 m²/g. In another example, the abrasive particle may include specific surface area of less than 2.2 m²/g, such as not greater than 1.8 m²/g, not greater than 1.6 m²/g, not greater than 1.3 m²/g, not greater than 1.2 m²/g, not greater than 1.1 m²/g, not greater than 0.96 m²/g, not greater than 0.94 m²/g, not greater than 0.91 m²/g, not greater than 0.88 m²/g, not greater than 0.86 m²/g, not greater than 0.83 m²/g, not greater than 0.8 m²/g, not greater than 0.76 m²/g, not greater than 0.73 m²/g, not greater than 0.71 m²/g, not greater than 0.68 m²/g, not greater than 0.66 m²/g, not greater than 0.63 m²/g, not greater than 0.6 m²/g, not greater than 0.58 m²/g, not greater than 0.55 m²/g, not greater than 0.54 m²/g, not greater than 0.52 m²/g, not greater than 0.5 m²/g, not greater than 0.47 m²/g, not greater than 0.45 m²/g, not greater than 0.42 m²/g, not greater than 0.4 m²/g, not greater than 0.38 m²/g, not greater than 0.37 m²/g, not greater than 0.36 m²/g, not greater than 0.34 m²/g, not greater than 0.31 m²/g, not greater than 0.3 m²/g, not greater than 0.28 m²/g, not greater than 0.27 m²/g, not greater than 0.25 m²/g, not greater than 0.23 m²/g, not greater than 0.21 m²/g, or not greater than 0.18 m²/g. Moreover, the abrasive particles may include specific surface area in a range including any of the minimum and maximum values noted herein. For example, the abrasive particles may include specific surface area in a range including at least 0.15 m²/g and not greater than 1.8 m²/g, or in a range including at least 0.18 m²/g and not greater than 1.2 m²/g, or in a range including at least 0.23 m²/g and not greater than 0.45 m²/g. As used herein, specific surface area may be determined using Brunauer-Emmett-Teller (BET) surface area analysis according to ISO 9277-2010 with nitrogen gas at bath temperature of 77.35K.

In a further embodiment, abrasive particles (i.e., 200 or 210 illustrated in FIGS. 2A and 2B respectively) having a particular average particle size may have improved specific surface area compared to corresponding conventional abrasive particle. As used herein, corresponding conventional abrasive particles may have the same average particle size and material but a conventional coating.

In an embodiment, abrasive particles having an average particle size of 600 to 650 microns may have particular specific surface area that may facilitate improved performance of abrasive particles. In an example, abrasive particles 200 or 210 having an average particle size of 600 to 650 microns may have particular specific surface area greater than 0.05 m²/g, such as at least 0.08 m²/g, at least 0.10 m²/g, at least 0.12 m²/g, at least 0.13 m²/g, at least 0.14 m²/g, at least 0.15 m²/g, at least 0.16 m²/g, at least 0.17 m²/g, or at least 0.18 m²/g. In another example, the abrasive particles 200 or 210 having an average particle size of 600 to 650 microns may include specific surface area of less than 0.50 m²/g, such as not greater than 0.48 m²/g, not greater than 0.46 m²/g, not greater than 0.43 m²/g, not greater than 0.40 m²/g, not greater than 0.38 m²/g, not greater than 0.36 m²/g, not greater than 0.34 m²/g, not greater than 0.31 m²/g, not greater than 0.28 m²/g, not greater than 0.26 m²/g, not greater than 0.23 m²/g, not greater than 0.21 m²/g, or not greater than 0.18 m²/g. Moreover, abrasive particles 200 or 210 having an average particle size of 600 to 650 microns may have specific surface area in a range including any of the minimum and maximum values noted herein. For example, abrasive particles 200 or 210 having an average particle size of 600 to 650 microns may have specific surface area in a range of greater than 0.05 m²/g and less than 0.50 m²/g, or in a range of at least 0.08 m²/g to not greater than 0.40 m²/g, or in a range of at least 0.10 m²/g to not greater than 0.34 m²/g, or in a range of at least 0.12 m²/g to not greater than 0.23 m²/g.

In another embodiment, abrasive particles 200 or 210 having an average particle size of 220 to 300 microns may have a particular specific surface area that may facilitate improved performance of abrasive particles. In an example, abrasive particles 200 or 210 having an average particle size of 220 to 300 microns may have specific surface area of greater than 0.15 m²/g, such as at least 0.16 m²/g, at least 0.17 m²/g, at least 0.18 m²/g, at least 0.19 m²/g, at least 0.21 m²/g, at least 0.23 m²/g, at least 0.25 m²/g, at least 0.26 m²/g, at least 0.28 m²/g, at least 0.29 m²/g, at least 0.31 m²/g, at least 0.32 m²/g, at least 0.33 m²/g, at least 0.35 m²/g, at least 0.37 m²/g, at least 0.38 m²/g, at least 0.39 m²/g, at least 0.4 m²/g, at least 0.42 m²/g, at least 0.44 m²/g, or at least 0.45 m²/g. In another example, the abrasive particles 200 or 210 having an average particle size of 220 to 300 microns may have specific surface area less than 1.10 m²/g, such as not greater than 0.96 m²/g, not greater than 0.94 m²/g, not greater than 0.91 m²/g, not greater than 0.88 m²/g, not greater than 0.86 m²/g, not greater than 0.83 m²/g, not greater than 0.8 m²/g, not greater than 0.76 m²/g, not greater than 0.73 m²/g, not greater than 0.71 m²/g, not greater than 0.68 m²/g, not greater than 0.66 m²/g, not greater than 0.63 m²/g, not greater than 0.6 m²/g, not greater than 0.58 m²/g, not greater than 0.55 m²/g, not greater than 0.54 m²/g, not greater than 0.52 m²/g, not greater than 0.5 m²/g, not greater than 0.47 m²/g, or not greater than 0.45 m²/g. Moreover, abrasive particles 200 or 210 having an average particle size of 220 to 300 microns may have specific surface area in a range including any of the minimum and maximum values noted herein. For example, abrasive particles having an average particle size of 220 to 300 microns may have specific surface area in a range of greater than 0.15 m²/g and less than 1.10 m²/g, or in a range including at least at least 0.28 m²/g and not greater than 0.66 m²/g, or in a range including at least 0.35 m²/g and not greater than 0.52 m²/g.

In still another embodiment, abrasive particles 200 or 210 having an average particle size of 80 to 110 microns may have a particular specific surface area that may facilitate improved performance of abrasive particles. In an example, abrasive particles 200 or 210 having an average particle size of 80 to 110 microns may have specific surface area of greater than 0.22 m²/g, such as at least 0.23 m²/g, at least 0.25 m²/g, at least 0.26 m²/g, at least 0.28 m²/g, at least 0.29 m²/g, at least 0.31 m²/g, at least 0.32 m²/g, at least 0.33 m²/g, at least 0.35 m²/g, at least 0.37 m²/g, at least 0.38 m²/g, at least 0.39 m²/g, at least 0.4 m²/g, at least 0.42 m²/g, at least 0.44 m²/g, at least 0.45 m²/g, at least 0.46 m²/g, at least 0.48 m²/g, at least 0.5 m²/g, at least 0.52 m²/g, at least 0.54 m²/g, at least 0.55 m²/g, at least 0.56 m²/g, at least 0.58 m²/g, at least 0.59 m²/g, at least 0.61 m²/g, at least 0.63 m²/g, at least 0.64 m²/g, or at least 0.66 m²/g. In another example, the abrasive particles 200 or 210 having an average particle size of abrasive particles having an average particle size of 80 to 110 microns may have specific surface area less than 2.2 m²/g, such as not greater than 1.8 m²/g, not greater than 1.6 m²/g, not greater than 1.3 m²/g, not greater than 1.2 m²/g, not greater than 1.1 m²/g, not greater than 0.96 m²/g, not greater than 0.94 m²/g, not greater than 0.91 m²/g, not greater than 0.88 m²/g, not greater than 0.86 m²/g, not greater than 0.83 m²/g, not greater than 0.8 m²/g, not greater than 0.76 m²/g, not greater than 0.73 m²/g, not greater than 0.71 m²/g, not greater than 0.68 m²/g, or not greater than 0.66 m²/g. Moreover, abrasive particles 200 or 210 having an average particle size of abrasive particles having an average particle size of 80 to 110 microns may have a specific surface area including any of the minimum and maximum values noted herein. For example, abrasive particles having an average particle size of abrasive particles having an average particle size of 80 to 110 microns may have specific surface area in a range of greater than 0.22 m²/g and less than 2.2 m²/g, or in a range from 0.38 m²/g to 0.94 m²/g, or in a range from 0.58 m²/g to 0.72 m²/g. In yet another embodiment, abrasive particles having an average particle size in a range from 80 to 650 microns may have specific surface area in a range from 0.15 m²/g to 0.72 m²/g or in a range from 0.18 m²/g to 0.66 m²/g.

Referring to FIG. 1, the process can continue to Block 104, to form a second portion of the coating overlying at least a portion of the core. Forming the second portion can include treating the cores with a second coating. In an embodiment, the second coating can include a coupling agent, for example, a silicon-containing compound, such as a silane or another organosilicon compound. In particular, the second coating can include organosilicon coupling agents that can provide improved binding between a surface having —OH functional groups and organic polymeric materials. For instance, the second coating can include organosilanes having amino, alkoxy, alkylalkoxy, alkyltrialkoxy, vinyl, acrylo, methacrylo, mercapto, or other functional groups, or any combination thereof. Particular example of silanes can include aminosilanes including, for instance, bis-aminosilane, aminoalkyltrialkoxysilanes, aminoethyltriethoxysilane, aminopropyltriethoxysilane, phenylaminoalkyltrialkoxysilane, or any combination thereof. Further example of organosilicon compound can include siloxanes, silicone fluids, silsesquioxanes, or the like, or any combination thereof.

In an exemplary implementation, the cores can be wetted with a solution including a silane in a solvent, such as water or ethanol. The concentration of silane can be in a range, for example, from 2 vol % to 6 vol %. In other implementations, spraying in-situ or other methods known in the art may be used to coat the cores with the second coating.

Forming the second portion of the coating may further include drying the wetted or otherwise coated cores. Drying may be conducted at a temperature from 20° C. to 180° C. for 10 minutes to up to 36 hours for the second portion the coating.

According to one embodiment, after applying the second portion 203, the finally-formed abrasive particles may include a particular content of silane-containing compound, including for example, but not limited to, at least 0.02 wt % of a silane-containing compound for a total weight of the coating. In another embodiment, the coating may include at least 0.5 wt % of the silane-containing compound for a total weight of the coating, such as at least 1 wt % or at least 2 wt % or at least 3 wt % or at least 4 wt % or at least 5 wt % or at least 6 wt % or at least 7 wt % or at least 8 wt % or at least 9 wt % or at least 10 wt %. Still, in another non-limiting embodiment, the coating may include not greater than 25 wt % of a silane-containing compound for a total weight of the coating, such as not greater than 20 wt % or not greater than 18 wt % or not greater than 16 wt % or not greater than 14 wt % or not greater than 12 wt % or not greater than 10 wt % of a total weight of the coating. It will be appreciated that the coating may include a content of the silane-containing compound within a range including any of the minimum and maximum values noted above.

Referring to FIG. 2B, a cross section of an abrasive particle 210 is provided and representative of an abrasive particle according to an alternative embodiment. In one embodiment, the abrasive particle 210 can include a core 201 and a coating 205 overlying the core 201. The coating 205 can include a first portion 202 overlying the core 201 and an optional second portion 203 overlying the first portion 202 and the core 201. The first portion 202 can be positioned between the surface of the core 201 and the second portion 203. In one non-limiting embodiment, the abrasive particle 210 can be formed by first forming the abrasive particle as provided in FIG. 2A by using steps 101, 102 and 103 and second forming an optional second portion 203 overlying the first portion of the core as provided in step 104.

In one non-limiting embodiment, the second portion 203 can be in direct contact with the first portion 202. In an embodiment, the second portion 203 can overlie the entire surface of the core 201, the entire first portion 202, or both. In one embodiment, the second portion 203 can overlie a majority of the first portion 202. For instance, a portion of the first portion 202 may not be covered by the second portion 203. In one embodiment, a portion of the core surface can be in direct contact with the second portion 203. In a further embodiment, the second portion 203 can bond to the first portion 202 and bond to the core 201.

In an embodiment, the second portion 203 of the coating 205 can include silane or a silane reaction product. The silane reaction product is intended to refer to a silane derivative that may be formed in the process of forming the coating. For example, one suitable silane or silane reaction product can include 3-aminopropyltriethoxysilane.

In an embodiment, the abrasive particle 210 or 201 can include an average content of the coating 205 or 202 of at least 0.01 wt % for the weight of the core 201, such as at least 0.02 wt %, at least 0.03 wt %, at least 0.04 wt %, at least 0.05 wt %, at least 0.06 wt %, at least 0.07 wt %, at least 0.08 wt %, at least 0.09 wt %, at least 0.1 wt %, at least 0.15 wt %, at least 0.16 wt %, at least 0.17 wt %, at least 0.18 wt %, at least 0.19 wt %, at least 0.2 wt %, at least 0.25 wt %, at least 0.26 wt %, at least 0.27 wt %, at least 0.28 wt %, at least 0.29 wt %, or at least 0.3 wt % for a weight of the core 201. As used herein, an average content of coating 205 or 202 can be an average of the coating contents of at least 5 abrasive particles 210 or 201. In another instance, abrasive particles 210 or 201 may include an average content of the coating 205 or 202 of not greater than 1 wt % for the weight of the core 201, not greater than 0.9 wt %, not greater than 0.8 wt %, not greater than 0.7 wt %, not greater than 0.6 wt %, not greater than 0.55 wt %, not greater than 0.5 wt %, not greater than 0.48 wt %, not greater than 0.46 wt %, not greater than 0.45 wt %, not greater than 0.43 wt %, not greater than 0.42 wt %, not greater than 0.41 wt %, not greater than 0.4 wt %, not greater than 0.38 wt %, not greater than 0.37 wt %, not greater than 0.36 wt %, not greater than 0.35 wt %, or not greater than 0.34 wt % for the weight of the core 201. Moreover, abrasive particles 210 can include an average content of coating 205 in a range including any of the minimum and maximum percentages noted herein.

In an embodiment, abrasive particles 210 can include a particular average thickness of coating 205 that can facilitate improved formation and properties of abrasive particle 210. For example, abrasive particle 210 may include an average thickness of coating 205 of not greater than 10 microns, not greater than 9 microns, not greater than 8 microns, not greater than 7 microns, not greater than 6 microns, not greater than 5 microns, not greater than 4 microns, not greater than 3 microns, not greater than 2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, or not greater than 0.2 microns. In another example, abrasive particle 210 can include an average thickness of coating 205 of at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16 microns, at least 0.17 microns, at least 0.18 microns, at least 0.19 microns, at least 0.20 microns, at least 0.21 microns, at least 0.22 microns, at least 0.24 microns, at least 0.26 microns, at least 0.28 microns, at least 0.29 microns, at least 0.30 microns, or at least 0.31 microns. Moreover, abrasive particles 210 can include an average thickness of coating 205 in a range including any of the minimum and maximum percentages noted herein. As used herein, an average thickness of coating 205 can refer to an average of thickness of coating 205 of at least 5 abrasive particles 210.

In an embodiment, abrasive particles 210 or 201 can include a particular ratio of an average thickness of coating 205 or 202 to an average particle size of core 201, respectively, that can facilitate improved formation and properties of abrasive particle 210. For example, the ratio can be less than 1, such as not greater than 0.9, not greater than 0.7, not greater than 0.5, not greater than 0.4, not greater than 0.2, not greater than 0.1, not greater than 0.08, not greater than 0.06, not greater than 0.05, not greater than 0.03, not greater than 0.02, not greater than 0.01, not greater than 0.009, not greater than 0.008, not greater than 0.007, not greater than 0.006, not greater than 0.005, not greater than 0.004, not greater than 0.003, not greater than 0.002, or not greater than 0.1. In another instance, the ratio of an average thickness of coating 205 or 202 to an average particle size of core 201 can be at least 0.0005, at least 0.0007, at least 0.0009, at least 0.001, at least 0.002, at least 0.003, at least 0.004, at least 0.005, at least 0.006, at least 0.007, at least 0.008, at least 0.009, at least 0.01, at least 0.02, or at least 0.03. Moreover, the ratio of an average thickness of coating 205 or 202 to an average particle size of core 201 can be in a range including any of the minimum and maximum percentages noted herein. As used herein, the average particle size of core 201 is intended to refer to D₅₀ of core 201.

In an embodiment, abrasive particles 210 and 201 can include an average particle size (i.e., D₅₀) of at least 10 microns, at least 30 microns, at least 40 microns, at least 50 microns, at least 60 microns, at least 70 microns, at least 80 microns, at least 90 microns, at least 100 microns, at least 120 microns, at least 140 microns, at least 150 microns, at least 170 microns, at least 180 microns, at least 200 microns, at least 210 microns, at least 230 microns, at least 250 microns, at least 260 microns, at least 270 microns, at least 290 microns, at least 300 microns, at least 320 microns, at least 340 microns, at least 350 microns, at least 360 microns, at least 380 microns, at least 400 microns, at least 420 microns, at least 430 microns, at least 440 microns, at least 450 microns, at least 460 microns, at least 470 microns, at least 490 microns, or at least 500 microns. In another embodiment, abrasive particles 210 and 201 may include an average particle size of not greater than 3 mm, such as not greater than 2 mm, not greater than 1.8 mm, not greater than 1.6 mm, not greater than 1.5 mm, not greater than 1.2 mm, not greater than 1 mm, not greater than 900 microns, not greater than 850 microns, not greater than 830 microns, not greater than 800 microns, not greater than 750 microns, not greater than 700 microns, not greater than 650 microns, not greater than 600 microns, not greater than 550 microns, not greater than 500 microns, not greater than 450 microns, or not greater than 400 microns. Moreover, abrasive particles 210 and 201 can include an average particle size in a range including any of the minimum and maximum values noted herein.

It is notable the abrasive particles of embodiments herein can have improved features, property, and/or performance compared to corresponding conventional abrasive particles. As used herein, corresponding conventional abrasive particles are intended to refer to abrasive particles that have the same core and coating to the abrasive particles of embodiments herein except the coating of the conventional abrasive particles is formed using a process different from the abrasive particles of embodiments herein. Such improved features of the abrasive particles can include morphology, coating coverage, average thickness of the coating, uniformity of the thickness of the coating, such as standard deviation of the coating thickness, average domain size of the coating, standard deviation of the domain size of the coating, or any combination thereof. In particular, the abrasive particles of embodiments herein have a sample size that is statistically relevant, and the improved features, property, and performance are described with respect to all the samples of the abrasive particles. For example, the abrasive particles can be at least 1 kg of abrasive particles, at least 2 kg of abrasive particles, at least 4 kg of abrasive particles, at least 5 kg of abrasive particles, at least 7 kg of abrasive particles, at least 8 kg of abrasive particles, at least 10 kg of abrasive particles, at least 20 kg of abrasive particles, at least 30 kg of abrasive particles, at least 50 kg of abrasive particles, at least 100 kg of abrasive particles, at least 250 kg, at least 500 kg, or at least 1 ton of abrasive particles. In another example, the abrasive particles can make up a significant percentage of abrasive particles from a fixed abrasive article. In still another example, the at least 100 abrasive particles, at least 500 abrasive particles, at least 1000 abrasive particles, at least 2000 abrasive particles, at least 5000 abrasive particles, at least 8000 abrasive particles, at least 10000 abrasive particles, or at least 500000 abrasive particles.

It is also notable that variables and parameters of the process of embodiments herein are controlled and/or adapted to facilitate formation of improved coating property and abrasive particles having the improved features, property, and performance. The process of embodiments herein can facilitate formation of abrasive particles having improved quality, compared to corresponding conventional abrasive particles. For example, the drying conditions, silica concentrations, mixing conditions, and/or other process features as noted in embodiments herein can help reduce formation of agglomerates of abrasive particles and prevent deterioration of core materials and formation of the improved coating. The abrasive particles can include coating that can be conformal and uniform.

In a further embodiment, the abrasive particles 201 or 210 can include an Anti-aging Factor of at least 5% better than a plurality of corresponding conventional abrasive particles, at least 8% better, at least 10% better, at least 12% better, at least 15% better, at least 18% better, at least 20% better, at least 22% better, at least 24% better, at least 25% better, at least 28% better, at least 30% better, at least 32% better, at least 35% better, at least 36% better, at least 38% better, or at least 40% better than a plurality of corresponding conventional abrasive particles.

In an embodiment, the coating 202 or 205 can have a particular hardness that can facilitate improved performance and/or property of the abrasive particles and abrasive articles. In an aspect, the hardness may be greater than 1 GPa, such as at least 1.5 GPa, at least 1.8 GPa, at least 2 GPa, at least 2.2 GPa, at least 2.5 GPa, at least 2.8 GPa, or at least 3 GPa. In another aspect, the hardness may be less than 10 GPa, such as less than 8 GPa, at most 7 GPa, at most 6 GPa, at most 5 GPa, at most 4 GPa, at most 3.8 GPa, at most 3.5 GPa, at most 3.3 GPa, at most 3.2 GPa, or at most 3 GPa. In a further aspect, the coating 202 or 205 can have a hardness in a range including any of the minimum and maximum values noted herein. The hardness can be determined as follows. The prepared suspension can be deposited on a flat alumina substrate (99.5% purity) by dip coating. The coated substrate can be dried as described in embodiments herein. Nanoindentation can be performed on the coated plate. 20 indents can be formed to determine the hardness of the coating.

FIG. 4 includes cross-sectional illustration of a bonded abrasive article 400 including a body 401 including abrasive particles 210 contained within a bond material 403. In at least one embodiment, the bond material 403 defines an interconnected and continuous phase throughout the entire volume of the body 401. In another embodiment, the bond material 403 can form a three-dimensional matrix. In another embodiment, the abrasive particles 201 can be used alone or in combination with abrasive particles 210 in forming the abrasive article 400.

In an embodiment, the abrasive particles 210 can bond to the bond material 403. In a further embodiment, a portion of the coating 203 can cross link to the bond material 403. For example, silane or silane derivative can cross link to the bond material in the process of forming the body 401.

In an embodiment, the bond material 403 can include an organic material, an inorganic material, a ceramic material, a vitreous material, a metal, or a metal alloy material. In a particular embodiment, the bond material 403 can include an organic material, such as one or more natural organic materials, synthetic organic materials, or a combination thereof. In particular instances, the organic material can be made of a resin, which may include a thermoset, a thermoplastic, and a combination thereof. For example, some suitable resins can include phenolics, epoxies, polyesters, cyanate esters, shellacs, polyurethanes, polybenzoxazines, polybismaleimides, polyimides, rubber, and a combination thereof.

The phenolic resin may be modified with a curing or cross-linking agent, such as hexamethylene tetramine. At temperatures in excess of about 90° C., some examples of the hexamethylene tetramine may form crosslinks to form methylene and dimethylene amino bridges that help cure the resin. The hexamethylene tetramine may be uniformly dispersed within the resin. More particularly, hexamethylene tetramine may be uniformly dispersed within resin regions as a cross-linking agent. Even more particularly, the phenolic resin may contain resin regions with cross-linked domains having a sub-micron average size.

In an embodiment, the body 401 can include a certain content of the bond material 403 that can facilitate improved formation of abrasive articles. In an instance, the body 401 may include not greater than 98 vol % the bond material 403 for a total volume of the body or not greater than 95 vol % or not greater than 90 vol % or not greater than 85 vol % or not greater than 80 vol % or not greater than 75 vol % or not greater than 70 vol % or not greater than 65 vol % or not greater than 60 vol % or not greater than 55 vol % or not greater than 50 vol % or not greater than 45 vol % or not greater than 40 vol % or not greater than 35 vol % or not greater than 30 vol % or not greater than 25 vol %. In another instance, the body 401 can include at least 1 vol % the bond material 403 for a total volume of the body or at least 2 vol % or at least 5 vol % or at least 10 vol % or at least 20 vol % or at least 30 vol % or at least 35 vol % or at least 40 vol % or at least 45 vol %. Moreover, the body 401 can include bond material 403 in a content including any of the minimum and maximum percentages noted herein.

In an embodiment, the body 401 can include a certain content of abrasive particles 210 and/or 201 that can facilitate improved properties and performance of abrasive articles. In an example, the body 401 may include not greater than 65 vol % abrasive particles 210 and/or 201 for a total volume of the body 401, such as not greater than 64 vol % or not greater than 62 vol % or not greater than 60 vol % or not greater than 58 vol % or not greater than 56 vol % or not greater than 54 vol % or not greater than 52 vol % or not greater than 50 vol % or not greater than 48 vol % or not greater than 46 vol % or not greater than 44 vol % or not greater than 42 vol % or not greater than 40 vol % or not greater than 38 vol % or not greater than 36 vol % or not greater than 34 vol % or not greater than 32 vol % or not greater than 30 vol % or not greater than 28 vol % or not greater than 26 vol % or not greater than 24 vol % or not greater than 22 vol % or not greater than 20 vol %. In another example, the body 901 can include at least 1 vol % abrasive particles 210 and/or 201 for a total volume of the body 401, such as at least 2 vol % or at least about 4 vol % or at least 6 vol % or at least 8 vol % or at least 10 vol % or at least 12 vol % or at least 14 vol % or at least 16 vol % or at least 18 vol % or at least 20 vol % or at least 25 vol % or at least 30 vol % or at least 35 vol % abrasive particles 210 and/or 201 for a total volume of the body 401. Moreover, the body 401 can include a content of abrasive particles 210 and/or 201 in a range including any of the minimum and maximum percentages noted herein.

In at least one embodiment, the body 401 can include abrasive particles including cores 201 having at least one different characteristic including composition, shape, hardness, particle size, friability, toughness, crystallite size, or any combination thereof. For example, cores 201 can include shaped abrasive particles and non-shaped particles or abrasive particles having different shapes. In a further instance, cores 201 can include a first type of abrasive particle including a premium abrasive particle (e.g., fused alumina, alumina-zirconia, seeded sol gel alumina, shaped abrasive particle, etc.) and a second type of abrasive particle including a diluent abrasive particle.

In an embodiment, the body 401 may include a certain content of uncoated abrasive grains in addition to abrasive particles 210 and/or 201. In another embodiment, the body 401 may include a blend of abrasive particles, wherein at least a portion of the blend may include abrasive particles 210 and/or 201. In an embodiment, the body 401 may include a particular content of abrasive particles 210 and/or 201 for a total content of abrasive particles in the body that may facilitate improved performance of the abrasive articles. In an example, the body may include at least 10% of abrasive particles 210 and/or 201 for the total volume content of the abrasive particles, such as at least 13%, at least 15%, at least 17%, at least 19%, at least 21%, at least 24%, at least 26%, at least 30%, at least 34%, at least 36%, at least 40%, at least 45%, at least 48%, at least 50%, at least 60%, at least 70%, at least 80%, at least 90%, or at least 95% of abrasive particles 210 and/or 201 for the total volume content of the abrasive particles. In a particular example, abrasive particles 210 and/or 201 may make up essentially all abrasive particles in the body 401. In a further example, the body may include not greater than 99% of abrasive particles 210 and/or 201 for the total volume content of the abrasive particles, such as not greater than 95%, not greater than 92%, not greater than 89%, not greater than 85%, not greater than 82%, not greater than 80%, not greater than 75%, not greater than 72%, not greater than 69%, not greater than 64%, not greater than 60%, not greater than 55%, not greater than 52%, not greater than 49%, not greater than 45%, not greater than 41%, not greater than 39%, not greater than 36%, not greater than 33%, or not greater than 30% of abrasive particles 210 and/or 201 for the total volume content of the abrasive particles. Moreover, the body may include a content of abrasive particles 210 and/or 201 in a range including any of the minimum and maximum percentages noted herein.

Referring to FIG. 4, the body 401 further includes a central opening 430 and an axial axis 931 extending through the central opening 430 in the axial direction, which can be perpendicular to a radial axis extending along a direction defining the diameter (d) of the body. It will be appreciated that any other fillers and/or phases (e.g., porosity) of the body can be contained within the bond material 403.

In an embodiment, the body 401 can include a type of porosity selected from the group consisting of closed porosity, open porosity, and a combination thereof. In an aspect, a majority of the porosity can be closed porosity defined by discrete pores, and in a particular aspect, the porosity can consist essentially of closed porosity. In another aspect, the majority of the porosity can be open defining a network of interconnected channels extending through at least a portion of the body, and in a particular aspect, essentially all of the porosity can be open porosity. In still another aspect, the porosity can include a combination of open and closed porosity.

In an embodiment, the body 401 can include a particular porosity that can facilitate improved properties and performance of abrasive articles. In an instance, the body 401 can include at least 1 vol % porosity for a total volume of the body or at least 2 vol % or at least 4 vol % or at least 6 vol % or at least 8 vol % or at least 10 vol % or at least 12 vol % or at least 14 vol % or at least 16 vol % or at least 18 vol % or at least 20 vol % or at least 25 vol % or at least 30 vol % or at least 40 vol % or at least 45 vol % or at least 50 vol % or at least 55 vol %. In another instance, the body 401 may include not greater than 80 vol % porosity for a total volume of the body or not greater than 75 vol % or not greater than 70 vol % or not greater than 65 vol % or not greater than 60 vol % or not greater than 55 vol % or not greater than 50 vol % or not greater than 45 vol % or not greater than 40 vol % or not greater than 35 vol % or not greater than 30 vol % or not greater than 25 vol % or not greater than 20 vol % or not greater than 15 vol % or not greater than 10 vol % or not greater than 5 vol % or not greater than 2 vol %. Moreover, the body 401 can include a porosity in a range including any of the minimum percentages and maximum percentages noted herein. Porosity of the body 401 was measured using Mercury Porosimetry (micromeritics AutoPore IV9520) to quantify the porosity in the body. A 1 cm×1 cm×1 cm sample was cut from the body and measured at low pressure (50 μm Hg) and high pressure (equilibrium Time 10 seconds) to get the bulk density and apparent density of the body. The porosity was then calculated by the equation: (porosity=[100−(bulk density/apparent density)].

In an embodiment, the body 401 can include filler. For example, the body 401 may include not greater than 40 vol % filler for the total volume of the body. In a particular instance, the body 401 can have not greater than 35 vol %, such as not greater than 30 vol % or not greater than 25 vol % or not greater than 20 vol % or not greater than 15 vol % or not greater than 10 vol % or not greater than 8 vol % or not greater than 5 vol % or not greater than 4 vol % or even not greater than 3 vol % filler. For at least one embodiment, the body 401 may have no filler. According to one non-limiting embodiment, the body 401 can have at least 0.05 vol % filler for the total volume of the body 401, such as at least 0.5 vol % or at least 1 vol % or at least 2 vol % or at least 3 vol % or at least 5 vol % or at least 10 vol % or at least 15 vol % or at least 20 vol % or even at least 30 vol % filler. Moreover, filler within the body 401 can be within a range between any of the minimum and maximum percentages noted above, including for example, but not limited to a content within a range of at least 0.5 vol % and not greater than 30 vol %.

The filler may include a material selected from the group consisting of powders, granules, spheres, fibers, and a combination thereof. Moreover, in particular instances, the filler can include an inorganic material, an organic material, fibers, woven materials, non-woven materials, particles, minerals, nuts, shells, oxides, alumina, carbide, nitrides, borides, polymeric materials, naturally occurring materials, and a combination thereof. In a certain embodiment, the filler can include a material such as sand, bubble alumina, chromites, magnesite, dolomites, bubble mullite, borides, titanium dioxide, carbon products (e.g., carbon black, coke or graphite), silicon carbide, wood flour, clay, talc, hexagonal boron nitride, molybdenum disulfide, feldspar, nepheline syenite, glass spheres, glass fibers, CaF₂, KBF₄, Cryolite (Na₃AlF₆), potassium Cryolite (K₃AlF₆), pyrites, ZnS, copper sulfide, mineral oil, fluorides, carbonates, calcium carbonate, wollastonite, mullite, steel, iron, copper, brass, bronze, tin, aluminum, kyanite, alusite, garnet, quartz, fluoride, mica, nepheline syenite, sulfates (e.g., barium sulfate), carbonates (e.g., calcium carbonate), titanates (e.g., potassium titanate fibers), rock wool, clay, sepiolite, iron sulfide (e.g., Fe₂S₃, FeS₂, or a combination thereof), potassium fluoroborate (KBF₄), zinc borate, borax, boric acid, fine alundum powders, P15A, cork, glass spheres, silica microspheres (Z-light), silver, Saran™ resin, paradichlorobenzene, oxalic acid, alkali halides, organic halides, attapulgite or any combination thereof.

In at least one embodiment, the filler may include a material selected from the group consisting of an antistatic agent, a lubricant, a porosity inducer, coloring agent, and a combination thereof. In particular instances wherein the filler is particulate material, it may be distinct from the abrasive particles, being significantly smaller in average particle size than the abrasive particles.

The body 401 is illustrated in cross section as having a generally rectangular shape, which may be representative of a wheel or disc shape with a central opening 430, such that it is an annulus. It will be appreciated that the abrasive articles of the embodiments herein can have a body that may be in the form of a hone, a cone, a cup, flanged shapes, a cylinder, a wheel, a ring, and a combination thereof.

The body 401 can have a generally circular shape as viewed top down. It will be appreciated, that in three-dimensions the body 401 can have a certain thickness (t) such that the body 401 has a disk-like or a cylindrical shape. As illustrated, the body 401 can have an outer diameter (d) extending through the center of the body 401. The central opening 430 can extend through the entire thickness (t) of the body 401 such that the abrasive article 400 can be mounted on a spindle or other machine for rotation of the abrasive article 400 during operation. According to one embodiment, the body 401 may have a particular relationship between the thickness (t) and the diameter (d), such that an aspect ratio (d:t) of the body is at least 10:1, such as at least 20:1 or at least 30:1 or at least 40:1 or at least 50:1 or at least 60:1 or at least 70:1 or at least 80:1 or at least 90:1 or at least 100:1. Still, in one non-limiting embodiment, the aspect ratio (d:t) may be not greater than 1000:1 or not greater than 500:1. It will be appreciated that the aspect ratio (d:t) can be within a range including any of the minimum and maximum values noted above.

In an aspect, the bonded abrasive article 400 according to an embodiment can have a Wet Retention value where the Wet Retention value is measured by dividing a wet MOR value of the bonded abrasive article by a dry MOR value of the bonded abrasive article and multiplying by 100. In a particular embodiment, the bonded abrasive article can have a Wet Retention value of at least 70% such as at least 71% or at least 72% or at least 73% or at least 74% or at least 75% or at least 76% or at least 77% or at least 78% or at least 79% or at least 80% or at least 81% or at least 82% or at least 83% or at least 84% or even at least 85%. Still, in one non-limiting embodiment, the Wet Retention value may be not greater than 99.9% or not greater than 99.5% or not greater than 99% or not greater than 98% or not greater than 96% or not greater than 94% or not greater than 92% or not greater than 90%. It will be appreciated that the Wet Retention value may be within a range including any of the minimum and maximum values noted above. The MOR of the abrasive article 400 was measured by a 3-point bending test performed on a Instron® universal testing machine using the parameters as follows: The test speed was 1.27 mm/min, support span was 50.8 mm, and the load cell was 10 kN. The 3-point bending test was performed on a bar sample representative of the abrasive article 400 having the dimension of 4.0×1.0×0.5 inches. At least three samples were tested to obtain the maximum flexure stress of the abrasive article (i.e. the Modulus of Rupture (MOR).

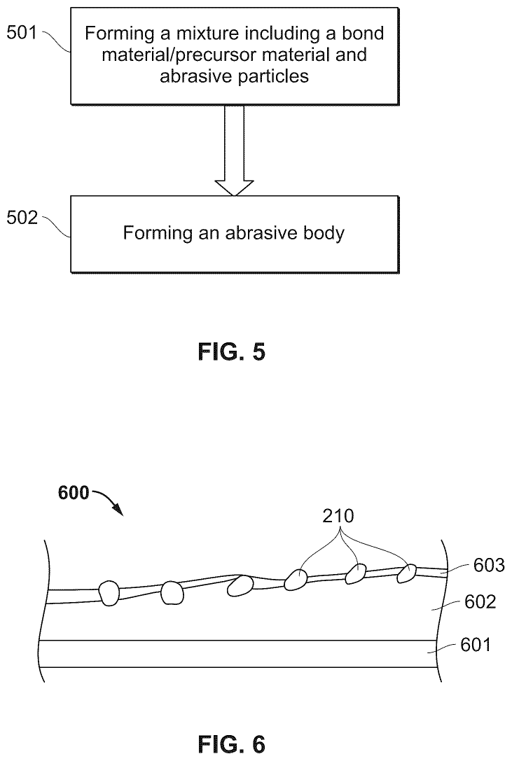

FIG. 5 includes an illustration of a process of forming an abrasive article including a body. At block 601, the process can include forming a mixture including a bond material and/or bond precursor material and abrasive particles.

According to one embodiment, the bond material and/or bond precursor material may include a material selected from the group consisting of an organic material, an organic precursor material, an inorganic material, an inorganic precursor material, a natural material, and a combination thereof. In particular instances, the bond material may include a metal or metal alloy, such as a powder metal material, or a precursor to a metal material, suitable for formation of a metal bond matrix material during further processing.

According to another embodiment, the mixture may include a vitreous material, or a precursor of a vitreous material, suitable for formation of a vitreous bond material during further processing. For example, the mixture may include a vitreous material in the form of a powder, including for example, an oxygen-containing material, an oxide compound or complex, a frit, and any combination thereof.

In yet another embodiment, the mixture may include a ceramic material, or a precursor of a ceramic material, suitable for formation of a ceramic bond material during further processing. For example, the mixture may include a ceramic material in the form of a powder, including for example, an oxygen-containing material, an oxide compound or complex, and any combination thereof.

According to another embodiment, the mixture may include an organic material, or a precursor of an organic material, suitable for formation of an organic bond material during further processing. Such an organic material may include one or more natural organic materials, synthetic organic materials, and a combination thereof. In particular instances, the organic material can be made of a resin, which may include a thermoset, a thermoplastic, and a combination thereof. For example, some suitable resins can include phenolics, epoxies, polyesters, cyanate esters, shellacs, polyurethanes, polybenzoxazines, polybismaleimides, polyimides, rubber, and a combination thereof. In one particular embodiment, the mixture includes an uncured resin material configured to form a phenolic resin bond material through further processing.

The phenolic resin may be modified with a curing or cross-linking agent, such as hexamethylene tetramine. At temperatures in excess of about 90° C., some examples of the hexamethylene tetramine may form crosslinks to form methylene and dimethylene amino bridges that help cure the resin. The hexamethylene tetramine may be uniformly dispersed within the resin. More particularly, hexamethylene tetramine may be uniformly dispersed within resin regions as a cross-linking agent. Even more particularly, the phenolic resin may contain resin regions with cross-linked domains having a sub-micron average size.

Other materials, such as a filler, can be included in the mixture. The filler may or may not be present in the finally-formed abrasive article. After forming the mixture, the process of forming the abrasive article can further include forming a green body comprising abrasive particles contained in a bond material. A green body is a body that is unfinished and may undergo further processing before a finally-formed abrasive article is formed. Forming of the green body can include techniques such as pressing, molding, casting, printing, spraying, and a combination thereof. In one particular embodiment, forming of the green body can include pressing the mixture into a particular shape, including for example, conducting a pressing operation to form a green body in the form of a grinding wheel.

It will also be appreciated that one or more reinforcing materials may be included within the mixture, or between portions of the mixture to create a composite body including one or more abrasive portions (i.e., abrasive particles contained within the bond material as well as porosity, fillers and the like) and reinforcing portions made up of the reinforcing materials. Some suitable examples of reinforcing materials include woven materials, non-woven materials, fiberglass, fibers, naturally occurring materials, synthetic materials, inorganic materials, organic materials, or any combination thereof. As used herein, terms such as “reinforced” or “reinforcement” refer to discrete layers or portions of a reinforcing material that is different from the bond and abrasive materials employed to make the abrasive portions. Terms such as “internal reinforcement” or “internally reinforced” indicate that these components are within or embedded in the body of the abrasive article. In cut-off wheels the internal reinforcement can be, for example, in the shape of a disc with a middle opening to accommodate the arbor hole of the wheel. In some wheels, the reinforcing materials extend from the arbor hole to the periphery of the body. In others, reinforcing materials can extend from the periphery of the body to a point just under the flanges used to secure the body. Some abrasive articles may be “zone reinforced” with (internal) fiber reinforcement around the arbor hole and flange areas of the body (about 50% of the diameter of the body).

After forming the mixture with the desired components and applying the mixture in the desired processing apparatus, the process can continue by treating the mixture to form a finally-formed abrasive article. Some suitable examples of treating can include curing, heating, sintering, crystallizing, polymerization, pressing, and a combination thereof. In one example, the process may include bond batching, mixing abrasive particles with bond or bond precursor materials, filling a mold, pressing, and heating or curing the mixture.

After finishing the treating process, the abrasive article, such as abrasive article 400, is formed, including abrasive particles and any other additives contained within the bond material.

FIG. 6 includes a cross-sectional illustration of a coated abrasive article 600 including a substrate 601, a make coat 602 overlying the substrate 601, and abrasive particles 210. The coated abrasive article 600 can optionally include filler, additives, or any combination thereof. A size coat 603 overlies and bonds to abrasive particles 210 and the make coat 602. In another embodiment, abrasive particles 200 may be used or in combination with abrasive particle 210 in forming the coated abrasive article 600.

In an embodiment, the substrate 601 can include an organic material, inorganic material, and a combination thereof. In certain instances, the substrate 601 can include a woven material. However, the substrate 601 may be made of a non-woven material. Particularly suitable substrate materials can include organic materials, including polymers, and particularly, polyester, polyurethane, polypropylene, polyimides such as KAPTON from DuPont, paper or any combination thereof. Some suitable inorganic materials can include metals, metal alloys, and particularly, foils of copper, aluminum, steel, and a combination thereof.

The make coat 602 can be applied to the surface of the substrate 601 in a single process, or alternatively, abrasive particles 210 can be combined with a make coat 602 material and the combination of the make coat 602 and abrasive particles 210 can be applied as a mixture to the surface of the substrate 601. In certain instances, controlled deposition or placement of abrasive particles 210 in the make coat 602 may be better suited by separating the processes of applying the make coat 602 from the deposition of abrasive particles 210 in the make coat 602. Still, it is contemplated that such processes may be combined. Suitable materials of the make coat 602 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 602 can include a polyester resin. The coated substrate can then be heated in order to cure the resin and bond abrasive particles 210 to the substrate 601. In general, the coated substrate 601 can be heated to a temperature of between about 100° C. to less than about 250° C. during this curing process.

After sufficiently forming the make coat 602 with abrasive particles 210 contained therein, the size coat 603 can be formed to overlie and bond abrasive particles 210 to the make coat 602 and the substrate 601. The size coat 603 can include an organic material, and may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiments

Embodiment 1. An abrasive particle comprising:
a body comprising:
a core; and
a coating overlying at least a portion of the core, wherein the coating comprises at least one of:
a) a lithium/silicon percent ratio within a range of at least 0.01% to not greater than 25%;
b) a potassium/silicon percent ratio within a range of at least 0.01% to not greater than 40%;
c) a sodium/silicon percent ratio within a range of at least 0.01% to not greater than 40%; or
d) any combination thereof.

Embodiment 2. The abrasive particle of Embodiment 1, wherein the lithium/silicon percent ratio is at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0%.

Embodiment 3. The abrasive particle of Embodiment 1, wherein the lithium/silicon percent ratio is not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3%.

Embodiment 4. The abrasive particle any one of Embodiments 1 and 82 to 84, wherein the coating comprises a lithium content of at least 0.01 wt % or at least 0.02 wt % at least 0.03 wt % at least 0.04 wt % at least 0.05 wt % at least 0.06 wt % at least 0.07 wt % at least 0.08 wt % or at least 0.09 wt % or at least 0.1 wt % or at least 0.15 wt % or at least 0.2 wt % or at least 0.25 wt % or at least 0.3 wt % or at least 0.35 wt % or at least 0.4 wt % or at least 0.5 wt % or at least 0.6 wt % or at least 0.7 wt % or at least 0.8 wt % or at least 0.9 wt % or at least 1.0 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2.0 wt % or at least 2.1 wt % or at least 2.2 wt % or at least 2.3 wt % or at least 2.4 wt % or at least 2.5 wt % or at least 2.6 wt %.

Embodiment 5. The abrasive particle of any one of Embodiments 1, 4, and 82 to 84, wherein the coating comprises a lithium content of not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt %.

Embodiment 6. The abrasive particle of any one of Embodiments 1, 4 to 5, and 82 to 84, wherein the coating comprises a silicon content of at least 80 wt % at least 81 wt % at least 82 wt % at least 83 wt % at least 84 wt % at least 85 wt % at least 86 wt % at least 87 wt % at least 88 wt % at least 89 wt % at least 90 wt % at least 91 wt % at least 92 wt % at least 93 wt % at least 94 wt % or at least 95 wt %.

Embodiment 7. The abrasive particle of any one of Embodiments 1, 4 to 6, and 82 to 84, wherein the coating comprises a silicon content of not greater than 99 wt % not greater than 98 wt % not greater than 97 wt % or not greater than 96 wt %.

Embodiment 8. The abrasive particle of Embodiment 1, wherein the potassium/silicon percent ratio is at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.1% or at least 3.2% or at least 3.4% or at least 3.6% or at least 3.8% or least 4.0%.

Embodiment 9. The abrasive particle of Embodiment 1, wherein potassium/silicon percent ratio is not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4%.

Embodiment 10. The abrasive particle of any one of Embodiments 1 and 82 to 84, wherein the coating comprises a potassium content of at least 0.01 wt % or at least 0.02 wt % at least 0.03 wt % at least 0.04 wt % at least 0.05 wt % at least 0.06 wt % at least 0.07 wt % at least 0.08 wt % or at least 0.09 wt % or at least 1 wt % at least 2 wt % at least 3 wt % at least 4 wt % at least 5 wt % at least 6 wt % at least 7 wt % at least 8 wt % at least 9 wt % or at least 10 wt %.

Embodiment 11. The abrasive particle of any one of Embodiments 1, 10, and 82 to 84, wherein the coating comprises a potassium content of not greater than 30 wt % not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt %.

Embodiment 12. The abrasive particle of any one of Embodiments 1 and 82 to 84, wherein the coating comprise a sodium/silicon percent ratio of not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4%% or not greater than 3% or not greater than 2% or not greater than 1% or not greater than 0.5%.

Embodiment 13. The abrasive particle of any one of Embodiments 1, 12, and 82 to 84, wherein the coating comprises a sodium/silicon percent ratio of at least 0.02% at least 0.03% at least 0.04% at least 0.05% at least 0.06% at least 0.07% at least 0.08% or at least 0.1% or at least 0.2% or at least 0.3% or at least 0.4% or at least 0.5% or at least 0.6% or at least 0.7% or at least 0.8% or at least 0.9% or at least at least 1.0% or at least 1.2% or at least 1.4% or at least 1.6% or at least 1.8% or at least 2.0% or at least 2.2% or at least 2.4% or at least 2.6% or at least 2.8% or at least 3.0% or at least 3.2% or at least 3.4% or at least 3.6% or at least 3.8% or least 4.0% or at least 4.2% or at least 4.4% or at least 4.6% or at least 4.8% or at least 5.0% or at least 5.2% or at least 5.4% or at least 5.5%.

Embodiment 14. The abrasive particle of any one of Embodiments 1, 12, 13, and 82 to 84, wherein the coating comprises a sodium content of not greater than 30 wt % not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt %. or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt %.

Embodiment 15. The abrasive particle of any one of Embodiments 1, 12 to 14, and 82 to 84, wherein the coating comprises a sodium content of at least 0.01 wt % or at least 0.05 wt % or at least 0.1 wt % or at least 0.2 wt % or at least 0.3 wt % or at least 0.5 wt % or at least 1.0 wt % or at least 1.5 wt % or at least 2.0 wt %.

Embodiment 16. The abrasive particle of any one of Embodiments 1 and 4 to 7, wherein the coating comprises a sodium content that is not greater than 10 times the lithium content as measured in wt % or wherein the coating comprises a sodium content that is not greater than 8 times the lithium content or wherein the coating comprises a sodium content that is not greater than 6 times the lithium content or wherein the coating comprises a sodium content that is not greater than 4 times the lithium content or wherein the coating comprises a sodium content that is not greater than 3 times the lithium content or wherein the coating comprises a sodium content that is not greater than 2.8 times the lithium content or wherein the coating comprises a sodium content that is not greater than 2.5 times the lithium content or wherein the coating comprises a sodium content that is not greater than 2.2 times the lithium content or wherein the coating comprises a sodium content that is not greater than 2 times the lithium content or wherein the coating comprises a sodium content that is not greater than 1.8 times the lithium content or wherein the coating comprises a sodium content that is not greater than 1.5 times the lithium content or wherein the coating comprises a sodium content that is not greater than 1.3 times the lithium content or wherein the coating comprises a sodium content that is not greater than 0.9 times the lithium content or wherein the coating comprises a sodium content that is not greater than 0.6 times the lithium content or wherein the coating comprises a sodium content that is not greater than 0.3 times the lithium content or wherein the coating comprises a sodium content that is not greater than 0.2 times the lithium content or wherein the coating comprises a sodium content that is not greater than 0.1 times the lithium content or wherein the coating comprises a sodium content that is not greater than 0.05 times the lithium content or wherein the coating comprises a sodium content that is not greater than 0.01 times the lithium content.

Embodiment 17. The abrasive particle of any one of Embodiments 1, 10, and 11, wherein the coating comprises a sodium content that is not greater than 10 times the potassium content as measured in wt % or wherein the coating comprises a sodium content that is not greater than 8 times the potassium content or wherein the coating comprises a sodium content that is not greater than 6 times the potassium content or wherein the coating comprises a sodium content that is not greater than 4 times the potassium content or wherein the coating comprises a sodium content that is not greater than 3 times the potassium content or wherein the coating comprises a sodium content that is not greater than 2.8 times the potassium content or wherein the coating comprises a sodium content that is not greater than 2.5 times the potassium content or wherein the coating comprises a sodium content that is not greater than 2.2 times the potassium content or wherein the coating comprises a sodium content that is not greater than 2 times the potassium content or wherein the coating comprises a sodium content that is not greater than 1.8 times the potassium content or wherein the coating comprises a sodium content that is not greater than 1.5 times the potassium content or wherein the coating comprises a sodium content that is not greater than 1.3 times the potassium content or wherein the coating comprises a sodium content that is not greater than 0.9 times the potassium content or wherein the coating comprises a sodium content that is not greater than 0.6 times the potassium content or wherein the coating comprises a sodium content that is not greater than 0.3 times the potassium content or wherein the coating comprises a sodium content that is not greater than 0.2 times the potassium content or wherein the coating comprises a sodium content that is not greater than 0.1 times the potassium content or wherein the coating comprises a sodium content that is not greater than 0.05 times the potassium content or wherein the coating comprises a sodium content that is not greater than 0.01 times the potassium content.

Embodiment 18. The abrasive particle of any one of Embodiments 1, 4 to 7 and 16, wherein the lithium comprises a lithium-containing compound.

Embodiment 19. The abrasive particle of Embodiment 18, wherein the lithium-containing compound comprises an oxide.

Embodiment 20. The abrasive particle of Embodiment 18, wherein the lithium-containing compound comprises lithium oxide.

Embodiment 21. The abrasive particle of any one of Embodiments 1 and 82 to 84, wherein the silicon comprises a silicon-containing compound.

Embodiment 22. The abrasive particle of Embodiment 21, wherein the silicon-containing compound comprises an oxide.

Embodiment 23. The abrasive particle of Embodiment 21, wherein the silicon-containing compound comprises silicon dioxide.

Embodiment 24. The abrasive particle of Embodiment 1, wherein the potassium comprises a potassium-containing compound.

Embodiment 25. The abrasive particle of Embodiment 24, wherein the potassium-containing compound comprises an oxide.

Embodiment 26. The abrasive particle of Embodiment 24, wherein the potassium-containing compound comprises potassium oxide.

Embodiment 27. The abrasive particle of Embodiment 1, wherein the sodium comprises a sodium-containing compound.

Embodiment 28. The abrasive particle of Embodiment 27, wherein the sodium-containing compound comprises an oxide.

Embodiment 29. The abrasive particle of Embodiment 27, wherein the sodium-containing compound comprises sodium oxide.

Embodiment 30. The abrasive particle of Embodiment 1, wherein the core comprises a ceramic material.

Embodiment 31. The abrasive particle of any one of Embodiments 1 and 82 to 84, wherein the core comprises an oxide, carbide, nitride, superabrasive, a boride, an oxycarbide, an oxynitride, carbon-based materials, agglomerates, aggregates, shaped abrasive particles, microcrystalline materials, nanocrystalline materials, or any combination thereof.

Embodiment 32. The abrasive particle of any one of Embodiments 1 and 82 to 84, wherein the core comprises an oxide selected from the group of alumina, silica, zirconia, or any combination thereof.

Embodiment 33. The abrasive particle of any one of Embodiments 1 and 82 to 84, wherein the core comprises fused alumina, sol-gel alumina, nanocrystalline alumina, brown fused alumina, or any combination thereof.

Embodiment 34. The abrasive particle of any one of Embodiments 1 and 82 to 84, wherein the core comprises a polycrystalline material made of a plurality of crystallite grains, wherein the crystallite grains have an average domain size of at least 50 nm and not greater than 3 mm.

Embodiment 35. The abrasive particle of any one of Embodiments 1 and 82 to 84, wherein the core comprises at least one of a monocrystalline phase, a polycrystalline phase, an amorphous phase or any combination thereof.

Embodiment 36. The abrasive particle of any one of Embodiments 1 and 82 to 84, wherein the coating comprises a total crystalline content of not greater than 99 vol % of the total volume of the coating or not greater than 97 vol % or not greater than 90 vol % or not greater than 80 vol % or not greater than 70 vol % or not greater than 60 vol % or not greater than 50 vol % or not greater than 40 vol % or not greater than 30 vol % or not greater 20 vol % or not greater than 10 vol % or not greater than 8 vol % or not greater than 5 vol % or not greater than 3 vol % or not greater than 2 vol % or not greater than 1 vol % of the total volume of the coating.

Embodiment 37. The abrasive particle of any one of Embodiments 1 and 82 to 84, wherein the core comprises a density of at least 2.10 g/cm³, at least 2.20 g/cm³, 2.30 g/cm³, at least 2.40 g/cm³, at least 2.50 g/cm³, at least 2.60 g/cm³, at least 2.70 g/cm³, 2.80 g/cm³, at least 2.90 g/cm³, at least 3.00 g/cm³, at least 3.10 g/cm³, at least 3.20 g/cm³, at least 3.30 g/cm³, at least 3.40 g/cm³, 3.50 g/cm³, at least 3.55 g/cm³, at least 3.60 g/cm³, at least 3.65 g/cm³, at least 3.70 g/cm³, at least 3.75 g/cm³, at least 3.80 g/cm³, at least 3.85 g/cm³, at least 3.90 g/cm³, or at least 3.95 g/cm³.

Embodiment 38. The abrasive particle of any one of Embodiments 1 and 82 to 84, wherein the core comprises a density of not greater than 5.80 g/cm³, not greater than 5.70 g/cm³, not greater than 5.60 g/cm³, not greater than 5.50 g/cm³, not greater than 5.40 g/cm³, not greater than 5.30 g/cm³, not greater than 5.20 g/cm³, not greater than 5.10 g/cm³, not greater than 5.00 g/cm³, not greater than 4.90 g/cm³, not greater than 4.80 g/cm³, not greater than 4.70 g/cm³, not greater than 4.60 g/cm³, not greater than 4.50 g/cm³, not greater than 4.40 g/cm³, not greater than 4.30 g/cm³, not greater than 4.20 g/cm³, not greater than 4.10 g/cm³, not greater than 4.00 g/cm³, or not greater than 3.97 g/cm³.

Embodiment 39. The abrasive particle of any one of Embodiments 1 and 82 to 84, wherein the core comprises a density of at least 80% of its theoretical density, at least 85%, at least 88%, at least 90%, at least 92%, at least 95%, or at least 98% of its theoretical density.

Embodiment 40. The abrasive particle of any one of Embodiments 1 and 82 to 84, wherein the core comprises a porosity not greater than 10 vol % for a total volume of the core, not greater than 9 vol %, not greater than 8 vol %, not greater than 7 vol %, not greater than 6 vol %, not greater than 5 vol %, not greater than 4 vol %, not greater than 3 vol %, not greater than 2 vol %, or not greater than 1 vol % for the total volume of the core.

Embodiment 41. The abrasive particle of any one of Embodiments 1 and 82 to 84, wherein the core is essentially free of pores.

Embodiment 42. The abrasive particle of any one of Embodiments 1 and 82 to 84, wherein the coating comprises a dried material.

Embodiment 43. The abrasive particle of any one of Embodiments 1 and 82 to 84, wherein the coating comprises an unsintered material.

Embodiment 44. The abrasive particle of any one of Embodiments 1 and 82 to 84, wherein the coating comprises an average coating thickness of at least 10 nm, at least 12 nm, at least 15 nm, at least 18 nm, at least 20 nm, at least 25 nm, at least 28 nm, at least 30 nm, at least 32 nm, at least 35 nm, at least 38 nm, at least 40 nm, at least 43 nm, at least 45 nm, at least 48 nm, at least 50 nm, at least 52 nm, at least 55 nm, at least 58 nm, at least 60 nm, at least 63 nm, at least 68 nm, at least 70 nm, at least 74 nm, at least 76 nm, at least 80 nm, at least 83 nm, at least 86 nm, at least 90 nm.

Embodiment 45. The abrasive particle of any one of Embodiments 1 and 82 to 84, wherein the coating comprises an average coating thickness of not greater than 150 nm, not greater than 140 nm, not greater than 130 nm, not greater than 120 nm, not greater than 110 nm, not greater than 100 nm.

Embodiment 46. The abrasive particle of any one of Embodiments 1 and 82 to 84, wherein the coating comprises a thickness standard deviation of not greater than 200% of the average thickness, not greater than 150%, not greater than 100%, not greater than 80%, not greater than 50%, not greater than 49%, not greater than 47%, not greater than 44%, not greater than 42%, not greater than 40%, not greater than 38%, not greater than 36%, not greater than 34%, not greater than 33%, not greater than 31%, not greater than 30%, not greater than 29%, not greater than 27%, not greater than 25%, not greater than 23%, not greater than 21%, not greater than 20%, not greater than 19%, not greater than 18%, not greater than 17%, not greater than 16%, not greater than 14%, not greater than 12%, not greater than 11%, not greater than 10%, not greater than 9%, not greater than 8%, not greater than 7%, not greater than 6%, not greater than 5%, not greater than 4%, not greater than 3%, not greater than 2%, not greater than 1%, not greater than 0.8%, not greater than 0.7%, or not greater than 0.5% of the average thickness of the coating.

Embodiment 47. The abrasive particle of any one of Embodiments 1 and 82 to 84, wherein the coating comprises a thickness standard deviation of at least 0.001% of the average thickness, at least 0.05%, at least 0.08%, at least 0.1%, at least 0.2%, at least 0.3%, at least 0.4%, at least 0.5%, at least 0.7%, at least 0.8%, at least 0.9%, at least 1%, at least 1.2%, at least 1.5%, at least 1.8%, at least 2%, at least 2.2%, at least 2.5%, at least 2.8%, at least 3%, at least 4%, or at least 5% of the average thickness of the coating.

Embodiment 48. The abrasive particle of any one of Embodiments 1 and 82 to 84, wherein the coating comprises an amorphous phase content within a range of at least 90 wt % for a total weight of the coating.

Embodiment 49. The abrasive particle of any one of Embodiments 1 and 82 to 84, wherein the coating consists essentially of an amorphous phase.

Embodiment 50. The abrasive particle of any one of Embodiments 1 and 82 to 84, further comprising a content of the coating of at least 0.01 wt % for a total weight of the core, at least 0.02 wt %, at least 0.03 wt %, at least 0.04 wt %, at least 0.05 wt %, at least 0.06 wt %, at least 0.07 wt %, at least 0.08 wt %, at least 0.09 wt %, at least 0.1 wt %, at least 0.15 wt %, at least 0.16 wt %, at least 0.17 wt %, at least 0.18 wt %, at least 0.19 wt %, at least 0.2 wt %, at least 0.25 wt %, at least 0.26 wt %, at least 0.27 wt %, at least 0.28 wt %, at least 0.29 wt %, or at least 0.3 wt % for a total weight of the core.

Embodiment 51. The abrasive particle of any one of Embodiments 1 and 82 to 84, further comprising a content of the coating of not greater than 1 wt % for a total weight of the core, not greater than 0.9 wt %, not greater than 0.8 wt %, not greater than 0.7 wt %, not greater than 0.6 wt %, not greater than 0.55 wt %, not greater than 0.5 wt %, not greater than 0.48 wt %, not greater than 0.46 wt %, not greater than 0.45 wt %, not greater than 0.43 wt %, not greater than 0.42 wt %, not greater than 0.41 wt %, not greater than 0.4 wt %, not greater than 0.38 wt %, not greater than 0.37 wt %, not greater than 0.36 wt %, not greater than 0.35 wt %, or not greater than 0.34 wt % for a total weight of the core.

Embodiment 52. The abrasive particle of any one of Embodiments 1 and 82 to 84, further comprising a ratio of an average coating thickness to an average particle size of the core, wherein the ratio is less than 1, not greater than 0.9, not greater than 0.7, not greater than 0.5, not greater than 0.4, not greater than 0.2, not greater than 0.1, not greater than 0.08, not greater than 0.06, not greater than 0.05, not greater than 0.03, not greater than 0.02, not greater than 0.01, not greater than 0.009, not greater than 0.008, not greater than 0.007, not greater than 0.006, not greater than 0.005, not greater than 0.004, not greater than 0.003, not greater than 0.002, or not greater than 0.1.

Embodiment 53. The abrasive particle of any one of Embodiments 1 and 82 to 84, further comprising a ratio of an average coating thickness to an average particle size of the core, wherein the ratio is at least 0.0005, at least 0.0007, at least 0.0009, at least 0.001, at least 0.002, at least 0.003, at least 0.004, at least 0.005, at least 0.006, at least 0.007, at least 0.008, at least 0.009, at least 0.01, at least 0.02, or at least 0.03.

Embodiment 54. The abrasive particle of any one of Embodiments 1 and 82 to 84, wherein the coating further comprises at least one silane-containing composition.

Embodiment 55. The abrasive particle of Embodiment 54, wherein the coating comprises at least 0.02 wt % of a silane-containing compound for a total weight of the coating or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt %, or further wherein the coating comprises not greater than 25 wt % of a silane-containing compound for a total weight of the coating, such as not greater than 20 wt % or not greater than 18 wt % or not greater than 16 wt % or not greater than 14 wt % or not greater than 12 wt % or not greater than 10 wt % of a total weight of the coating.

Embodiment 56. The abrasive particle of any one of Embodiments 1 and 82 to 84, wherein the abrasive particle has an average particle size of at least at least 10 microns, at least 30 microns, at least 40 microns, at least 50 microns, at least 60 microns, at least 70 microns, at least 80 microns, at least 90 microns, at least 100 microns, at least 120 microns, at least 140 microns, at least 150 microns, at least 170 microns, at least 180 microns, at least 200 microns, at least 210 microns, at least 230 microns, at least 250 microns, at least 260 microns, at least 270 microns, at least 290 microns, at least 300 microns, at least 320 microns, at least 340 microns, at least 350 microns, at least 360 microns, at least 380 microns, at least 400 microns, at least 420 microns, at least 430 microns, at least 440 microns, at least 450 microns, at least 460 microns, at least 470 microns, at least 490 microns, or at least 500 microns.

Embodiment 57. The abrasive particle of any one of Embodiments 1 and 82 to 84, wherein the abrasive particle has an average particle size of not greater than 3 mm, such as not greater than 2 mm, not greater than 1.8 mm, not greater than 1.6 mm, not greater than 1.5 mm, not greater than 1.2 mm, not greater than 1 mm, not greater than 900 microns, not greater than 850 microns, not greater than 830 microns, not greater than 800 microns, not greater than 750 microns, not greater than 700 microns, not greater than 650 microns, not greater than 600 microns, not greater than 550 microns, not greater than 500 microns, not greater than 450 microns, or not greater than 400 microns.

Embodiment 58. A fixed abrasive article including the abrasive particle of any one of Embodiments 1 and 82 to 84.

Embodiment 59. The fixed abrasive article of Embodiment 58, wherein the abrasive article has a Wet Retention value of at least 70% such as at least 71% or at least 72% or at least 73% or at least 74% or at least 75% or at least 76% or at least 77% or at least 78% or at least 79% or at least 80% or at least 81% or at least 82% or at least 83% or at least 84% or even at least 85%.

Embodiment 60. A batch of abrasive particles including the abrasive particle of any one of Embodiments 1 and 82 to 84.

Embodiment 61. The batch of abrasive particles of Embodiment 60, wherein the batch includes at least 10 wt % of the abrasive particle of Embodiment 1 for a total weight of the abrasive particles in the batch or at least 20 wt % or at least 30 wt % or at least 40 wt % or at least 50 wt % or at least 60 wt % or at least 70 wt % or at least 80 wt % or at least 90 wt %.

Embodiment 62. The batch of abrasive particles of Embodiment 60, wherein the batch consists essentially of the abrasive particles of Embodiment 1.

Embodiment 63. The batch of abrasive particles of Embodiment 60, wherein the abrasive particles include any one or more combination of features of any of the Embodiments or embodiments herein.

Embodiment 64. A method for forming an abrasive particle or plurality of abrasive particles comprising:
a) providing a core; and
b) forming a coating overlying at least a portion of the core; wherein the coating comprises any one or more features of any of the Embodiments and/or embodiments herein.

Embodiment 65. The method of Embodiment 64, wherein forming includes heating the coating at a temperature of not greater than 800° C. or not greater than 700° C. or not greater than 600° C. or not greater than 500° C. or not greater than 400° C. or not greater than 300° C. or not greater than 250° C.

Embodiment 66. The method of Embodiment 64, wherein forming includes heating the coating at a temperature of at least 20° C. or at least 30° C. or at least 40° C. or at least 50° C. or at least 60° C. or at least 70° C. or at least 80° C. or at least 90° C. or at least 100° C. or at least 110° C. or at least 120° C. or at least 130° C. or at least 140° C. or at least 150° C.

Embodiment 67. The method of Embodiment 64, further comprising providing a silane-containing material, a silanol-containing material or a combination thereof overlying the coating.

Embodiment 68. The method of Embodiment 64, further comprising disposing the abrasive particle or plurality of abrasive particles in a fixed abrasive article.

Embodiment 69. The method of Embodiment 64, further comprising disposing the abrasive particle or plurality of abrasive particles in a bonded abrasive article.

Embodiment 70. The method of Embodiment 64, further comprising disposing the abrasive particle or plurality of abrasive particles in a bonded abrasive article comprising an organic bond material.

Embodiment 71. The method of Embodiment 70, wherein the organic bond material comprises at least one of phenolics, epoxies, polyesters, cyanate esters, shellacs, polyurethanes, polybenzoxazines, polybismaleimides, polyimides, rubber, or a combination thereof.

Embodiment 72. An abrasive particle comprising:
a body comprising:
a core; and
a coating overlying at least a portion of the core, wherein the coating comprises a total crystalline content of not greater than 60 vol % of the total volume of the coating,
wherein the coating comprises at least one silicate-containing compound and at least one silica-containing compound; and
wherein the coating comprises a silicate/silica percent ratio of at least 10% and not greater than 1000%.

Embodiment 73. The abrasive particle of any one of Embodiments 72 and 82 to 84, wherein the coating comprises a total crystalline content of not greater than 50 vol % or not greater than 40 vol % or not greater than 30 vol % or not greater 20 vol % or not greater than 10 vol % or not greater than 8 vol % or not greater than 5 vol % or not greater than 3 vol % or not greater than 2 vol % or not greater than 1 vol %.

Embodiment 74. The abrasive particle of Embodiment 72, wherein the one silicate-containing compound comprises at least one of a sodium silicate, potassium silicate, lithium silicate or a combination thereof.

Embodiment 75. The abrasive particle of Embodiment 72 or 84, wherein the silica-containing compound comprises silicon dioxide.

Embodiment 76. The abrasive particle of any one of Embodiments 72 and 82 to 84, wherein the coating comprises a silica-containing compound content of at least 1 wt % for a total weight of the coating or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt %.

Embodiment 77. The abrasive particle of any one of Embodiments 72 and 82 to 84, wherein the coating comprises a silica-containing compound content of not greater than 99 wt % for a total weight of the coating or not greater than 95 wt % or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt %.

Embodiment 78. The abrasive particle of Embodiment 72, wherein the coating comprises a silicate-containing compound content of at least 1 wt % for a total weight of the coating or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt %.

Embodiment 79. The abrasive particle of any one of Embodiments 72 and 82 to 84, wherein the coating comprises a silicate-containing compound content of not greater than 99 wt % for a total weight of the coating or not greater than 95 wt % or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt %.

Embodiment 80. The abrasive particle of Embodiment 72 or 79, wherein the percent ratio of silicate/silica is at least 15% or at least 20% or at least 25% or at least 30% or at least 35% or at least 40% or at least 45% at least 50% or at least 60% or at least 70% or at least 80% or at least 90% or at least 100%.

Embodiment 81. The abrasive particle of Embodiment 72 or 79, wherein the silicate/silica percent ratio is not greater than 1000% or not greater than 900% or not greater than 800% or not greater than 700% or not greater than 600% or not greater than 500% or not greater than 400% or not greater than 300% 200% or not greater than 190% or not greater than 180% or not greater than 170% or not greater than 60% or not greater than 150% or not greater than 140% or not greater than 130% or not greater than 120% or not greater than 110% or not greater than 100% or not greater than 90% or not greater than 80% or not greater than 70% or not greater than 60% or not greater than 50% or not greater than 40% or not greater than 30% or not greater than 20% or not greater than 15% or not greater than 10% or not greater than 9% or not greater than 8% or not greater than 7% or not greater than 6% or not greater than 5% or not greater than 4%.

Embodiment 82. An abrasive particle, comprising:
a core including a ceramic material;
a coating including silicon and oxygen overlying at least a portion of the core, wherein
   the coating comprises:
   nanoparticles;
   a binder material; and
   nanopores.

Embodiment 83. An abrasive particle, comprising:
a core including a ceramic material comprising a magnetoplumbite phase; and
a coating overlying at least a portion of the core, wherein the coating comprises:
   nanoparticles;
   a binder material; and
   nanopores.

Embodiment 84. The abrasive particle of Embodiment 82 or 23, wherein the nanoparticles comprise silica and wherein the binder material comprises a silica-containing compound.

### EXAMPLES

### Example 1

A representative sample of abrasive particles was formed by first making a coating mixture including 7.01 grams of Silica available as DS-13 from Qingdao FUSO Co., Ltd., and 2.65 grams of lithium silicate available as Lith Crys® A48 from Dongguan Songshi Chemical Co., Ltd. and 20.34 grams of DI water. The ratio of the components in the mixture was 72 wt % colloidal silica solution and 28 wt % lithium silicate solution was formed having the properties in Table 1. White Alumina 38A (white fused alumina (α-Al₂O₃>99%, 60 grit) particles were used as core particles that were coated with the coating mixture by mixing 1000.0 grams of fused alumina particles with 13.0 grams of the coating mixture for 1 to 5 minutes using a mixer. The wet and coated abrasive particles were dried in a normal atmosphere at 150° C. for 14 hours to form coated abrasive particles (i.e., Sample S1). The particles were not sintered and had a total crystalline content of 0 vol % for a total volume of the coating.

TABLE 1

| Composition | Chemistry of Coating Mixture | Formulation |
|---|---|---|
| Colloidal Silica Solution | SiO₂ in water: (conc. 30% SiO₂) | 72 wt % |
| Lithium Silicate Solution | Li₂O•nSiO₂ (n = 4.8) in water; | 28 wt % |
| | (conc. 20% SiO₂) | |

ICP Analysis Technique. The following is the ICP analysis technique used herein to evaluate the composition of the coating, in particular, the inorganic materials in the coating. ICP analysis was done on the coating layer of Sample 1. The results of which are in Table 3. Sample 1 had 1.14 wt % of Li and 45.62 wt % of Si for the total weight of the coating, a lithium/silicon percent ratio of 2.9%, and a sodium/silicon ratio of 5.9%. Analysis was done by first weighing 20.0 grams of Sample S1 and adding 2 mL of hydrochloric acid, 0.5 mL of nitric acid and 10 mL of hydrofluoric acid. The sample was then sealed in a digestion tank at 100° C. for 1 hour. The sample was then filtered and the filtrate was measured by ICP-OES using the machine parameters provided in Table 2.

TABLE 2
Parameters:

| Machine | Agilent 5110 | |
|---|---|---|
| Reading time | 5 | s |
| RF power | 1.20 | KW |
| Stabilizing time | 15 | s |
| Atomizing gas flow rate | 0.7 | L/min |
| Plasma gas flow rate | 12 | L/min |

TABLE 3
ICP of the Coating Layer

| Composition | wt % |
|---|---|
| Li₂O | 2.69% |
| SiO₂ | 91.89% |
| Na₂O | 5.42% |

### Example 2

A second representative example of coated particles, S2, were made following the same procedures as Si of Example 1 except the coating mixture for the abrasive particles was 72 wt % colloidal silica solution and 28 wt % potassium silicate solution available as DY-4.0 from Xingtai Dayang Chemical Co., Ltd. having the properties in Table 4. The particles were not sintered and had a total crystalline content of 0 vol % for a total volume of the coating.

TABLE 4

| Composition | Chemistry of Coating Mixture | Formulation |
|---|---|---|
| Colloidal Silica | SiO₂ in water: (conc. 30% SiO₂) | 72 wt % |
| Solution | | |
| Potassium Silicate | K₂O•nSiO₂ (n = 4.0) in water; | 28 wt % |
| Solution | (conc. 20% SiO₂) | |

ICP analysis was done on the coating layer of S2. The results of which are in Table 5. Sample 2 had a potassium/silicon percent ratio of about 3.2 to 7.7% and a sodium/silicon ratio of about 2.1% to 5.5%.

TABLE 5
ICP of the Coating Layer S2

| Composition | wt % |
|---|---|
| K₂O | 3-7% |
| SiO₂ | 91-95% |
| Na₂O | 2-5% |

### Example 3

A third representative example of coated particles, S3, were made following the same procedures as Si of Example 1 except the coating mixture for the abrasive particles was 80 wt % colloidal silica solution and 20 wt % sodium silicate solution available as TPY-2.8 from Xingtai Dayang Chemical Co., Ltd. having the properties in Table 6. The particles were not sintered and had a total crystalline content of 0 vol % for a total volume of the coating.

TABLE 6

| Composition | Chemistry of Coating Mixture | Formulation |
|---|---|---|
| Colloidal Silica Solution | SiO₂ in water: (conc. 30% SiO₂) | 80 wt % |
| Sodium Silicate Solution | Na₂O•nSiO₂ (n = 2.8) in water; | 20 wt % |
| | (conc. 30% SiO₂) | |

ICP analysis was done on the coating layer of S3. The results of which are in Table 7. Sample 3 had a sodium/silicon percent ratio of about 5.3 to 17.6%.

TABLE 7
ICP of the Coating Layer S3

| Composition | wt % |
|---|---|
| Na₂O | 5-15% |
| SiO₂ | 85-95% |

### Example 4

A comparative coated particle, CS1, was made by mixing White Alumina 38A particles with Silica available as DS-13 from Qingdao FUSO Co., Ltd., at a silica content of 0.1 wt % for a total weight of the alumina particles for 3 to 5 minutes. A portion of the wetted particles were sintered at 850° C. for 15 minutes to form coated particle Sample CS1 and had a total crystalline content of 63 vol % for a total volume of the coating.

### Example 5

A second comparative coated particle, CS2, was made by mixing White Alumina 38A particles with Silica available as DS-13 from Qingdao FUSO Co., Ltd., at a silica content of 0.1 wt % for a total weight of the alumina particles for 3 to 5 minutes. A portion of the wetted particles were dried at 150° C. for 14 hours to form coated abrasive particles and had a total crystalline content of 0 vol % for a total volume of the coating.

### Example 6

A third comparative coated particle, CS3, was made by first making a coating mixture including 2.88 grams of potassium silicate solution available as DY-4.0 from Xingtai Dayang Chemical Co., Ltd. and 10.38 grams of lithium silicate available as Lith Crys® A48 from Dongguan Songshi Chemical Co., and 16.74 grams of DI water. The ratio of the components in the mixture was 78 wt % lithium silicate solution and 22 wt % potassium silicate solution was formed having the properties in Table 8. White Alumina 38A (white fused alumina (α-Al₂O₃)) particles were used as core particles that were coated with the coating mixture by mixing 1000.0 grams of fused alumina particles with 13.0 grams of the coating mixture for 1 to 5 minutes using a mixer. The wet and coated abrasive particles were dried at 150° C. for 14 hours to form coated abrasive particles (i.e., Sample CS3). The particles were not sintered and had a total crystalline content of 0 vol % for a total volume of the coating.

TABLE 8

| Composition | Chemistry of Coating Mixture | Formulation |
|---|---|---|
| Potassium Silicate | K₂O•nSiO₂ (n = 4.0) in water; | 22 wt % |
| Solution | (conc. 20% SiO₂) | |
| Lithium Silicate | Li₂O•nSiO₂ (n = 4.8) in water; | 78 wt % |
| Solution | (conc. 20% SiO₂) | |

### Example 7

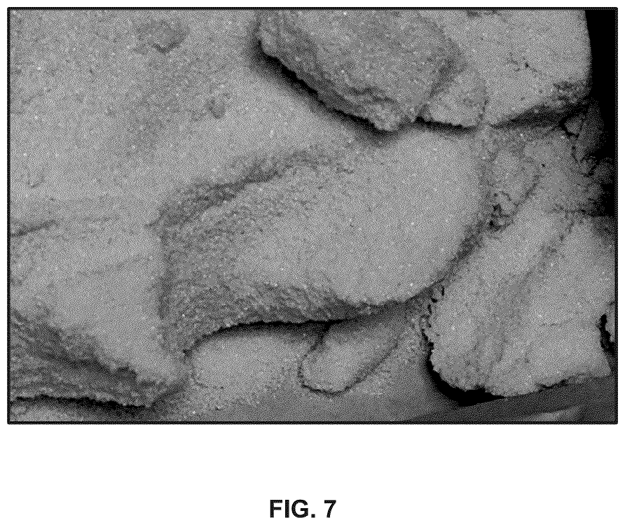

A fourth comparative coated particle, CS4, was made by first making a coating mixture including 8.76 grams sodium silicate solution available as TPY-2.8 from Xingtai Dayang Chemical Co., Ltd. and 21.24 grams of DI water. The component in the mixture was 100 wt % sodium silicate having the properties in Table 9. White Alumina 38A (white fused alumina (α-Al₂O₃)) particles were used as core particles that were coated with the coating mixture by mixing 1000.0 grams of fused alumina particles with 13.0 grams of the coating mixture for 1 to 5 minutes using a mixer. The wet and coated abrasive particles were dried at 150° C. for 14 hours to form coated abrasive particles (i.e., Sample CS4). The particles were not sintered and had a total crystalline content of 0 vol % for a total volume of the coating. The particles of CS4 were unusable due to notable agglomeration of the particles, which is presumed to be because of the coating composition. Sample CS4 includes 19.98 wt % of Na and 34.18 wt % of Si for the total weight of the coating. See agglomeration of the particles in FIG. 7.

TABLE 9

| Composition | Chemistry of Coating Mixture | Formulation |
|---|---|---|
| Sodium Silicate | Na₂O•nSiO₂ (n = 4.0) in water; | 100 wt % |
| Solution | (conc. 30% SiO₂) | |

### Example 8

A fifth comparative coated particle, CS5, was made by first making a coating mixture including 13.27 g potassium silicate solution available as DY-4.0 from Xingtai Dayang Chemical Co., Ltd. and 16.73 grams of DI water. The component in the mixture was 100 wt % potassium silicate having the properties in Table 10. White Alumina 38A (white fused alumina (α-Al₂O₃)) particles were used as core particles that were coated with the coating mixture by mixing 1000.0 grams of fused alumina particles with 13.0 grams of the coating mixture for 1 to 5 minutes using a mixer. The wet and coated abrasive particles were dried at 150° C. for 14 hours to form coated abrasive particles (i.e., Sample CS5). The particles were not sintered and had a total crystalline content of 0 vol % for a total volume of the coating.

TABLE 10

| Composition | Chemistry of Coating Mixture | Formulation |
|---|---|---|
| Potassium Silicate | K₂O•nSiO₂ (n = 4.0) in water; | 100 wt % |
| Solution | (conc. 20% SiO₂) | |

### Example 9

The coated alumina particles of Samples S1, S2, S3, CS1, CS2, CS3, CS4, and CS5 were further treated with 3-aminopropyltriethoxysilane and dried under 150° C. for 14 hours to form abrasive particles.

### Example 10

The coated alumina particles of Example 3 were used to form Abrasive Wheels S1, Abrasive Wheel S2, Abrasive Wheel S3, Abrasive Wheel CS1, Abrasive Wheel CS2, and Abrasive Wheel CS4, using their corresponding abrasive particle samples respectively.

Abrasive wheel S1 was made using 74.3 grams of Sample S1 abrasive particles mixed with a bond mixture comprising phenolic resin for 2-7 minutes until all of the Sample S1 abrasive particles were coated by the bond mixture to form an abrasive mixture. The abrasive mixture was then molded and cold pressed to desired size under 300 ton Press Machine at room temperature to make a green body abrasive wheel. The green body abrasive wheel was removed from the mold and heat treated to cure in an oven at 160° C. for 15 hours.

All other abrasive wheels (including Abrasive Wheel S2, Abrasive Wheel S3, Abrasive Wheel CS1, Abrasive Wheel CS2, and Abrasive Wheel CS4) were formed using the same bond mixture composition as Abrasive Wheel S1 and made according to the same process as Abrasive Wheel S1 except each wheel used its corresponding abrasive particle as listed above (i.e., Wheel S2 included the S2 grains instead of the S1 abrasive particles, Wheel S3 included the S3 abrasive particles instead of the abrasive particles of S1, etc.). All wheels were formed to have the same abrasive wheel structure, including porosity content, abrasive grain content and bond mixture content as Abrasive Wheel S1.

Dry and Wet Flexural strength (i.e., MOR) were tested for all abrasive wheels. To measure the wet MOR, samples were soaked in boiled water for 2.5 hours prior to measuring. A summary of the dry and wet MOR are summarized in Table 11. Wet Retention was measured by dividing the wet MOR by dry MOR and multiplying by 100. MOR was measured according to the three-point bending test as disclosed.

TABLE 11

| | | | Wet Retention |
|---|---|---|---|
| | Dry MOR | Wet MOR | ((wet/dry |
| Wheel Sample | (MPa) | (MPa) | MOR) × 100) |
| Abrasive Wheel S1 | 35 | 28 | 80% |
| Abrasive Wheel S2 | 35 | 27 | 77% |
| Abrasive Wheel S3 | 33 | 27 | 82% |
| Abrasive Wheel CS1 | 35 | 29 | 83% |
| Abrasive Wheel CS2 | 12 | 7 | 58% |
| Abrasive Wheel CS4 | n/a | n/a | n/a |

Surprisingly, it is noted that the Abrasive Wheels with a dried coating (i.e. S1, S2, and S3) were statistically equivalent in their performance when compared to Abrasive Wheel CS1 including abrasive particles with sintered coatings. Abrasive particles made by a process at a lower temperature can be beneficial for both sustainability and manufacturing.

### Example 11

Another representative sample of abrasive particles S11 was formed as follows. Abrasive grains CG-2 were coated with the coating mixture noted in Table 1 in the same manner as described in Example 1. The coated grains were further treated with 3-aminopropyltriethoxysilane and dried under 150° C. for 14 hours to form abrasive particles S11. The properties and composition of CG-1 and CG-2 grains are described in Table 12. Abrasive particle sample S11 includes 1.18 wt % of Li and 45.58 wt % of Si in the coating for the total weight of the coating.

TABLE 12

| | He | | HV | Chemistry | | | | |
|---|---|---|---|---|---|---|---|---|
| | Density | LPD | Hardness | Al2O3 | ZrO2 | MgO | La2O3 | Y2O3 |
| | (g/cm³) | (g/cm³) | (GPa) | (wt %) | (wt %) | (wt %) | (wt %) | (wt %) |
| CG-1 | 3.90-4.00 | 1.72 | 20-24 | 95-98 | 1.5-3.3 | 0.5-1.5 | <0.02 | <0.02 |
| CG-2 | 3.82-4.00 | 1.96 | 16.5-20.5 | 93.5-96.5 | <0.02 | 0.5-1.8 | 1.5-4.0 | 0.35-1.75 |

The density may be measured using Pycnometer AccuPyc II 1340 or equivalent as follows: weighing the amount of a grain sample that can fill more than 75% volume of the sample cup with nominal volumes of 10 cm³ by using analytical balances with readability to 0.1 mg or 0.0001 g; closing the cap for absolute density testing.

LPD may be measured using a Loose pack density tester of conventional abrasive particles, such as DMP-II type from ZSSM or an equivalent according to GB/T 20316.1-2009.

As disclosed in Table 12, CG-2 grains demonstrate lower hardness and increased toughness compared to CG-1 grains.

Abrasive wheel Samples S12 to S14 and CS15 to CS19 were made using their respective mixtures including abrasive particles and same bond material (i.e. phenolic resins). The abrasive mixtures were molded and cold pressed under 300 ton Press Machine at room temperature to form green bodies, which were then removed from the mold and cured at 160° C. for 15 hours. Samples S12 to S14 were made using a blend of abrasive particles including abrasive particles of Samples S11. All the abrasive particles were 36 grits.

Sample S12 included 46 vol % of abrasive particles (11 vol % S11 particles, 26 vol % Monocrystalline Alumina grains, 9 vol % Green Silicon Carbide grains), 19 vol % of the bond material, and 35 vol % of porosity for the total volume of the wheel body.

Sample S13 included 46 vol % of abrasive particles (19 vol % S11 particles, 18 vol % Monocrystalline Alumina grains, 9 vol % Green Silicon Carbide grains), 19 vol % of bond material, and 35 vol % of porosity for the total volume of the wheel body.

Sample S14 included 46 vol % of abrasive particles (26 vol % S11 particles, 11 vol % Monocrystalline Alumina grains, 9 vol % Green Silicon Carbide grains), 19 vol % of bond material, and 35 vol % of porosity for the total volume of the wheel body.

Samples CS15, CS16, and CS17 were made with CG-2 grains (uncoated). Sample CS15 included 46 vol % of abrasive grains (11 vol % CG-2 grains, 26 vol % Monocrystalline Alumina grains, 9 vol % Green Silicon Carbide grains), 19 vol % of bond material, and 35 vol % of porosity for the total volume of the wheel body.

Sample CS16 (5WhitecutAG 36 G B37) included 46 vol % of abrasive grains (19 vol % CG-2 grains, 18 vol % Monocrystalline Alumina grains, 9 vol % Green Silicon grains), 19 vol % of bond material, and 35 vol % of porosity for the total volume of the wheel body.

Sample CS17 included 46 vol % of abrasive particles (26 vol % CG-2 grains, 11 vol % Monocrystalline Alumina grains, 9 vol % Green Silicon Carbide grains), 19 vol % of bond material comprising phenolic resin, and 35 vol % of porosity for the total volume of the wheel body.

Samples CS18 and CS19 were made with CG-1 grains. All the abrasive grains were 36 grits. Sample CS18 included 46 vol % of abrasive particles (11 vol % CG-1 grains, 26 vol % Monocrystalline Alumina grains, 9 vol % Green Silicon Carbide grains), 19 vol % of bond material, and 35 vol % of porosity.

Sample CS19 included 46 vol % of abrasive particles (19 vol % CG-1 grains, 18 vol % Monocrystalline Alumina grains, 9 vol % Green Silicon Carbide grains), 19 vol % of bond material comprising phenolic resin, and 35 vol % of porosity for the total volume of the wheel body.

Modulus of Rupture (MOR) was tested on bar samples cut from Wheel Samples S12 to S14 and CS15 to CS19 under dry and wet conditions. MOR was tested according to embodiments herein. A set of bar samples were soaked in boiled water for 2.5 hours, and then tested for MOR. The results were used as wet MOR. MOR tested on another set of bars without soaking was used as dry MOR. Wet retention of the bar samples was determined by the formula, Wet Retention=(dry MOR/wet MOR)×100 and included in Table 13 below. Samples S12, S13, and S14 demonstrated improved wet retention compared to Samples CS15-CS19.

Wheel Samples S12 to S14 and CS15 to CS19 were subjected to grinding tests using M2 steel as the workpieces. G-ratios of wheel samples at the MRR of 1.2 mm³/s/mm are included in Table 13 below. Sample CS16 and CS17 demonstrated similar G-ratios, despite differences in contents of abrasive particles and performed slightly better compared to CS15 (approximately 6% increase in the G-ratio). It is to be appreciated higher G-ratio indicates better performance. Sample CS16 and CS17 had a higher contents of abrasive particles compared to Sample CS18 but demonstrated similar G-ratios to Sample CS18. Sample CS 19 demonstrated a higher G-ratio compared to Samples CS15 to CS18. Samples S12 and CS15 had a similar content of abrasive particles, but Sample S12 demonstrated an improved G-ratio over CS15. Samples S13 and CS19 demonstrated similar wet retention, while Sample 14 demonstrated higher G-ratio compared to Sample CS19.

TABLE 13

| Wheel | Wet Retention | |
|---|---|---|
| Specification | from MOR test | G-ratio |
| S12 | 92% | 1.9 |
| S13 | 88% | 2.4 |
| S14 | 90% | 2.6 |
| CS15 | 69% | 1.7 |
| CS16 | 69% | 1.8 |
| CS17 | 74% | 1.8 |
| CS18 | 63% | 1.8 |
| CS19 | 82% | 2.3 |

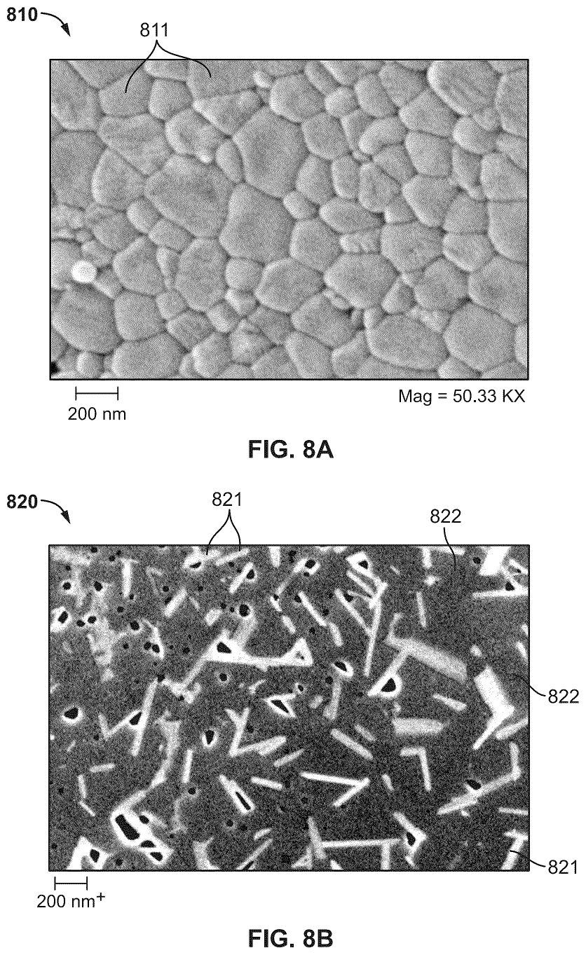

FIG. 8A includes a scanning electron microscope (SEM) image of a portion of an NQ grain 810 including α-alumina crystallites 811. FIG. 8B includes an SEM image of a portion of a Whitecut grain 820 including a primary crystalline phases 822 and a secondary magnetoplumbite crystalline phase 821. The primary crystalline phase 822 includes α-alumina crystallites. The secondary phase 821 includes rare earth aluminate.

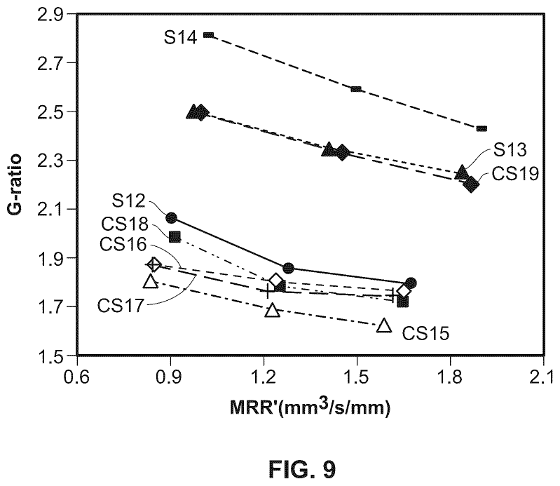

FIG. 9 includes a plot of material removal rate (MRR) vs. G-ratio of wheel Samples S12 to S14 and CS15 to CS19. As illustrated, for a given material removal rate, Wheel Sample S14 demonstrated higher G-ratios over wheel Samples S12, S13, and CS16 to CS19. Sample S13 demonstrated similar G-ratios to CS19 over the tested material removal rates and higher G-ratios compared to Samples S12 and CS15 to CS18. Sample S12 demonstrated improved G-ratios compared to Samples CS15 to CS 18.

### Example 12

White Alumina 38A grains of 36 grits were used to form abrasive particle Samples CS20 to CS22. CQ-2 grains of 36 grits were used to form abrasive particle Sample S24.

Sample CS20 was formed by mixing 1000.0 grams of the abrasive particles with 13.0 grams of the formulation in Table 14 using a mixer. The wetted abrasive particles were sintered at 850° C. for 15 minutes to form coated grains, which were further treated with 3-aminopropyltriethoxysilane and dried under 150° C. for 14 hours to form coated abrasive particles of Sample CS20. Sample CS20 does not include Li in the coating.

TABLE 14

| Composition | Chemistry of Coating Mixture | Formulation |
|---|---|---|
| Colloidal Silica | SiO₂ in water: (conc. 34% SiO₂) | 26 grams |
| Solution | | |
| DI water | H₂O | 74 grams |

Sample CS21 was formed by mixing 1000.0 grams of the abrasive particles with 13.0 grams of the formulation of Table 15 using a mixer. The wetted abrasive particles were dried at 150° C. for 14 hours in air to form coated grains, which were further treated with 3-aminopropyltriethoxysilane and dried under 150° C. for 14 hours to form coated abrasive particles of Sample CS21. Sample CS21 includes 42.38 wt % of Si and 4.36 wt % of Li for the total weight of the coating.

TABLE 15

| Composition | Chemistry of Coating Mixture | Formulation |
|---|---|---|
| Lithium Silicate | Li₂O•nSiO₂ (n = 4.8); conc. 20% SiO₂ | 44 grams |
| Solution | | |
| DI water | H₂O | 56 grams |

Sample CS22 was formed by mixing 1000.0 grams of the abrasive particles with 13.0 grams of the formulation of Table 15 using a mixer. The wetted abrasive particles were sintered at 850° C. for 15 minutes to form coated grains, which were further treated with 3-aminopropyltriethoxysilane and dried under 150° C. for 14 hours to form coated abrasive particles of Sample CS22. Sample CS22 includes 42.44 wt % of Si and 4.32 wt % of Li for the total weight of the coating.

Sample CS23 was formed by mixing 1000.0 grams of the abrasive particles with 13.0 grams of the formulation of Table 14 using a mixer. The wet and coated abrasive particles were dried at 150° C. for 14 hours in air to form coated grains, which were further treated with 3-aminopropyltriethoxysilane and dried under 150° C. for 14 hours to form coated abrasive particles of Sample CS23. Sample CS20 does not include Li in the coating.

Sample S24 was formed by first treating CQ-2 grains in the same manner as described with respect with Sample S1. The coated grains were further treated with 3-aminopropyltriethoxysilane and dried under 150° C. for 14 hours to form coated abrasive particles of Sample S24. Sample S24 includes 45.43 wt % of Si and 1.25 wt % of Li for the total weight of the coating.

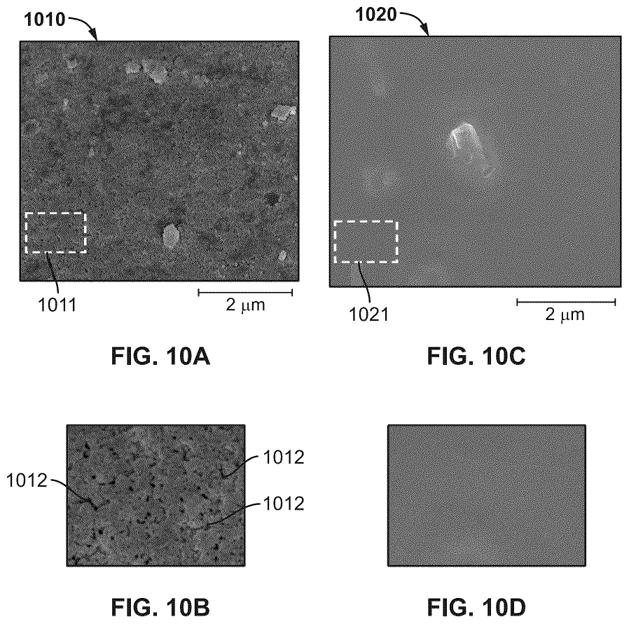

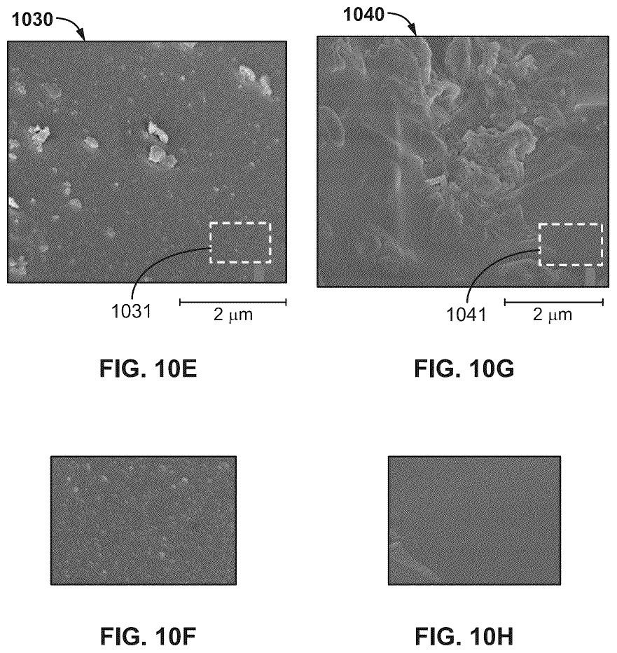

FIG. 10A includes an SEM image demonstrating a portion of the coating of Sample S1 1010 under 50,000× magnification. FIG. 10B includes a further magnified view (100,000× magnification) of the boxed region 1011 of FIG. 10A. As demonstrated, the coating 1010 includes nanopores 1012 and appears relatively rough.

FIG. 10C includes an SEM image demonstrating a portion of the coating of Sample CS20 1020 under 50,000× magnification. FIG. 10D includes a further magnified view (100,000× magnification) of the boxed region 1021 of FIG. 10C. As demonstrated, the coating 1020 appears relatively smooth and smoother than the coating 1010 of FIG. 10A. Within the selected area of approximately 1.5 μm×0.75 μm, nanopores are not observed.

FIG. 10E includes an SEM image demonstrating a portion of the coating of Sample CS21 1030 under 50,000× magnification. FIG. 10F includes a further magnified view (100,000× magnification) of the boxed region 1031 of FIG. 10E. As demonstrated, the coating 1030 appears relatively rough. Within the selected area of approximately 1.5 μm×0.75 μm, nanopores are not observed.

FIG. 10G includes an SEM image demonstrating a portion of the coating of Sample CS22 1040 under 50,000× magnification. FIG. 10H includes a further magnified view (100,000× magnification) of the boxed region 1041 of FIG. 10G. As demonstrated, the coating 1030 appears relatively smooth and smoother than the coating 1010 of FIG. 10G. Within the selected area of approximately 1.5 μm×0.75 μm, nanopores are not observed.

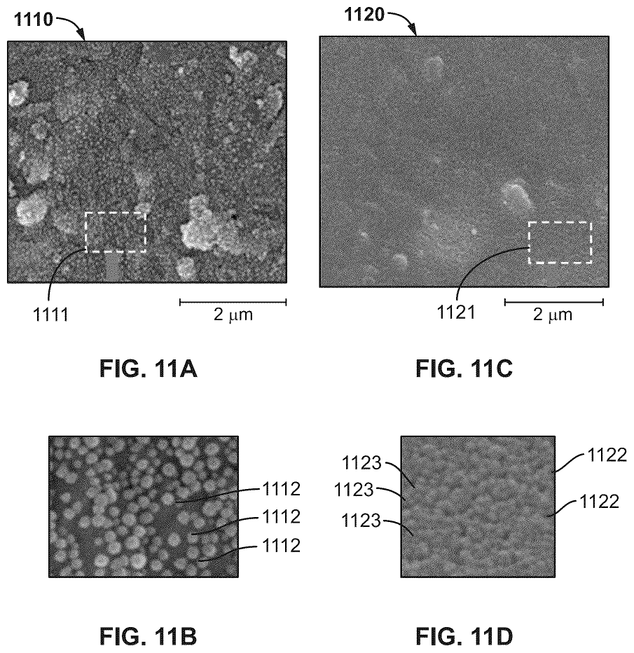

FIG. 11A includes an SEM image demonstrating a portion of the coating of Sample CS23 1110 under 100,000× magnification. FIG. 11B includes a further magnified view (200,000× magnification) of the boxed region 1111 of FIG. 11A. As demonstrated, the coating 1110 includes discrete silica nanoparticles 1112.

FIG. 11C includes an SEM image demonstrating a portion of the coating of Sample S24 1120 under 100,000× magnification. FIG. 11D includes a further magnified view (200,000× magnification) of the boxed region 1121 of FIG. 11C. As demonstrated, the coating 1120 includes nanopores 1122 and agglomerated nanoparticles 1123 including silicate binder and silica nanoparticles. The coating 1120 includes less discrete nanoparticles compared to CS23.

### Example 13

Representative abrasive particle samples S25-S30 and S34 were formed in the same manner as described with respect to abrasive particles S11 except that compositions of the coating mixtures noted in Table 16 were used. Table 16 further includes the contents of Li and Si (wt %) for the total weight of the coating and the weight content ratios of Li/Si. Samples S25-S30 and S34 include approximately 0.8 wt % to 1 wt % of Na for the total weight of the coating. The contents of elements in the coating are determined by ICP as described in embodiments and Example 1 in this disclosure.

TABLE 16

| | SiO₂ | Li₂O•nSiO₂ | | | | |
|---|---|---|---|---|---|---|
| | in water: | in water; | | | | |
| | (conc. 30% | (conc. 20% | | | | |
| | SiO₂) | SiO₂) | | | | |
| Sam- | (weight | (weight | | Li | Si | |
| ples | by part) | by parts) | | content | content | Li/Si |
| S25 | 1 | 0.375 | (n = 20) | 0.23 wt % | 46.54 wt % | 0.005 |
| S26 | 1 | 0.375 | (n = 10) | 0.46 wt % | 46.31 wt % | 0.01 |
| S27 | 1 | 0.375 | (n = 3.95) | 1.15 wt % | 45.60 wt % | 0.025 |
| S28 | 1 | 0.375 | (n = 1.97) | 2.23 wt % | 44.53 wt % | 0.05 |
| S29 | 1 | 0.375 | (n = 1.24) | 3.46 wt % | 43.28 wt % | 0.08 |

| | | | | | |
|---|---|---|---|---|---|
| S30 | 1 | 0.375 (n is the | 1.19 wt % | 45.56 wt % | 0.025 |
| | | same as S27) | | | |
| S34 | 1 | 0.375 (n is the | 1.12 wt % | 45.64 wt % | 0.025 |
| | | same as S27) | | | |

Abrasive particle samples CS31 and CS32 were formed using sodium silicate by mixing 1000.0 grams of CG-2 grains with 13.0 grams of the coating mixture, Na₂O·nSiO₂ (n=4.0) in water; (conc. 30% SiO₂), for 1 to 5 minutes using a mixer. The wet and coated abrasive particles were dried at 150° C. for 14 hours to form coated abrasive particles CS31 and CS32. Abrasive particle samples CS31 and CS32 include approximately 20 wt % to 25 wt % of Na for the total weight of the coating.

Abrasive bar samples were formed in the same manner as described in Example 11 using the abrasive particle samples as noted in Table 17. All the bar samples include 46 vol % of abrasive grains (19 vol % coated CG-2 grains, 18 vol % Monocrystalline Alumina grains, 9 vol % Green Silicon grains), 19 vol % of phenolic bond material, and 35 vol % of porosity for the total volume of the body of the bars. Modulus of Rupture (MOR) and wet retention of the abrasive bar samples was determined according to embodiments herein and as described in Example 11. Variations in wet retention between samples made using CS31-CS32 may be due to agglomeration of particles as noted in Example 7 when sodium silicate solution is used as a coating solution.

TABLE 17

| Abrasive | | |
|---|---|---|
| particles in | | |
| bar sample | Li wt % | Wet Retention |
| S25 | 0.23 | 84.36% |
| S26 | 0.46 | 84.77% |
| S27 | 1.15 | 83.81% |
| S28 | 2.23 | 85.48% |
| S29 | 3.46 | 78.62% |
| S30 | 1.19 | 82% |
| CS31 | 0 | 67% |
| CS32 | 0 | 74% |
| S34 | 1.12 | 84% |

### Example 14

Abrasive particle samples are formed and specific surface areas are measured according to embodiments herein using Micromeritics® TriStar II Plus. The results are included in Table 18.

Sample group S35 are formed. The group includes abrasive particle samples S35-1, S35-2, and S35-3 formed in the same manner as sample S11 except CG-2 grains having the average particle sizes of 24 grits, 60 grits, and 180 grits are used as cores, respectively.

Sample group S36 includes abrasive particle samples S36-1, S36-2, and S36-3 that are formed in the same manner as sample CS20 except CG-2 grains having the average particle sizes of 24 grits, 60 grits, and 180 grits are used as cores, respectively.

Sample group S37 includes abrasive particle samples S37-1, S37-2, and S37-3 that are formed in the same manner as sample CS21 except CG-2 grains having the average particle sizes of 24 grits, 60 grits, and 180 grits are used as cores, respectively.

Sample group S38 includes abrasive particle samples S38-1, S38-2, and S38-3 that are formed in the same manner as sample CS4 except CG-2 grains having the average particle sizes of 24 grits, 60 grits, and 180 grits are used as cores, respectively.

Sample group S39 includes abrasive particle samples S39-1, S39-2, and S39-3 that are formed in the same manner as sample CS23 except CG-2 grains having the average particle sizes of 24 grits, 60 grits, and 180 grits are used as cores, respectively.

TABLE 18

| Sample | Specific surface area | | |
|---|---|---|---|
| Group | 24 grits | 60 grits | 180 grits |
| S35 | 0.18 m²/g | 0.45 m²/g | 0.66 m²/g |
| S36 | 0.05 m²/g | 0.15 m²/g | 0.22 m²/g |
| S37 | 0.03 m²/g | 0.04 m²/g | 0.05 m²/g |
| S38 | 0.05 m²/g | 0.10 m²/g | 0.18 m²/g |
| S39 | 0.50 m²/g | 1.10 m²/g | 2.20 m²/g |

### Example 15

Abrasive particle samples S40-S46 are formed using coating mixtures of colloidal silica solution and lithium silicate solutions or lithium silicate solutions to have the Li and Si contents (wt %) for the total weight of the coating as noted in Table 19 below. Abrasive bar samples are formed using the abrasive particle samples S40-S46 and dry and wet MOR and wet retention of the bar samples will be tested in the same manner as described in Example 11.

TABLE 19

| Abrasive | Li/Si | | | |
|---|---|---|---|---|
| particles in | (wt % | | | |
| bar samples | ratio) | Li content | Si content | Wet Retention |
| S40 | 0.03 | 1.36 wt % | 45.50 wt % | To be tested |
| S41 | 0.04 | 1.80 wt % | 44.46 wt % | To be tested |
| S42 | 0.1 | 4.25 wt % | 42.49 wt % | To be tested |
| S43 | 0.15 | 6.10 wt % | 40.63 wt % | To be tested |
| S44 | 0.2 | 7.79 wt % | 38.93 wt % | To be tested |
| S45 | 0.25 | 9.34 wt % | 37.36 wt % | To be tested |
| S46 | 0.3 | 10.78 wt % | 35.91 wt % | To be tested |

The foregoing embodiments represent a departure from the state-of-the-art. Embodiments are directed to abrasive particles including a coating overlying a core. In particular, the abrasive particles can include a thin conformal coating with improved average thickness and uniformity, which can facilitates improvement of performance of the abrasive particles in fixed abrasives, such as lowering the friction associated with their use in material removal operations, anti-ageing, and a chemical and mechanical bonding of the conformal layer to the surface of the abrasive particles (i.e., core particles). Furthermore, the abrasive particles can have improved bonding strength and reduced moisture absorption and/or permeation and be particularly suitable for use in coated abrasives and thin wheels.

Abrasive articles formed with representative abrasive particles further demonstrate improved performance and properties, such as wet MoR, G-Ratio, and MMR over abrasive articles including abrasive particles including a dried coating. Not wishing to be bound to any theory, improved properties and performance of abrasive articles may be facilitated by a feature or features of the abrasive particles including one or more of Li contents, Si contents, contents of Na, content ratios thereof, specific surface area, roughness, another chemistry or morphology feature, or any combination thereof.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An abrasive particle comprising:
a body comprising:
a core; and
a coating overlying at least a portion of the core, wherein the coating comprises a lithium content of at least 0.02 wt % and not greater than 20 wt % for a total weight of the coating.

2. The abrasive particle of claim 1, wherein the coating comprises an amorphous phase including lithium.

3. The abrasive particle of claim 1, wherein the lithium content is at least 0.10 wt % for the total weight of the coating.

4. The abrasive particle of claim 1, wherein the coating comprises silicon, oxygen, or a combination thereof.

5. The abrasive particle of claim 1, wherein the coating comprises a silicon content of at least 21 wt % for the total weight of the coating.

6. The abrasive particle of claim 1, wherein the coating comprises a lithium/silicon percent ratio within a range of at least 0.01% to not greater than 250%, a content of sodium of not greater than 12 wt % for the total weight of the coating, or any combination thereof.

7. An abrasive article, comprising a body including a bond material and abrasive particles contained in the bond material, wherein the abrasive particles comprise the abrasive particle of claim 1.

8. An abrasive particle, comprising:
a body comprising:
a core; and
a coating overlying at least a portion of the core, wherein the coating comprises an amorphous phase including a lithium-containing material.

9. The abrasive particle of claim 8, wherein the coating comprises a lithium content of at least 0.10 wt % and not greater than 20 wt % for a total weight of the coating

10. The abrasive particle of claim 9, wherein the coating comprises a silicon content of at least 21 wt % for the total weight of the coating.

11. The abrasive particle of claim 8, wherein the core comprises non-agglomerated particle, non-shaped abrasive particles, shaped abrasive particle, or any combination thereof.

12. The abrasive particle of claim 8, comprising a specific surface area of greater than 0.05 m²/g and less than 2.2 m²/g.

13. The abrasive particle of claim 8, wherein the core comprises a ceramic material including a magnetoplumbite phase.

14. An abrasive article, comprising a body including a bond material and abrasive particles contained in the bond material, wherein at least 10 vol % of the abrasive particles for a volume of the body comprise the abrasive particle of claim 8.

15. An abrasive particle comprising:
a body comprising:
a core; and
a coating overlying at least a portion of the core, wherein the coating comprises lithium and silicon, wherein a weight content of silicon is higher than a weight content of lithium.

16. The abrasive particle of claim 15, wherein the coating comprises a lithium content of at least 0.05 wt % and a silicon content of at least 21 wt % for a total weight of the coating.

17. The abrasive particle of claim 15, wherein the coating comprises oxygen.

18. The abrasive particle of claim 15, wherein the coating comprises nanoparticles, wherein the nanoparticles comprise silicon, oxygen, or a combination thereof.

19. The abrasive particle of claim 15, wherein the core comprises a material comprising an oxide, a carbide, a nitride, boride, an oxycarbide, an oxynitride, a silicate, or any combination thereof.

20. An abrasive article, comprising a bond material including an organic material and abrasive particles contained in the bond material, wherein at least 10% of a volume content of the abrasive particles comprise the abrasive particle of claim 15.
